(19) United States
(12) Patent Application Publication
(10) Pub. No.: US 2019/0228134 A1
(43) Pub. Date: Jul. 25, 2019

(54) INFORMATION PROCESSING APPARATUS, INFORMATION PROCESSING SYSTEM, AND NON-TRANSITORY COMPUTER-READABLE STORAGE MEDIUM FOR STORING PROGRAM

(71) Applicant: FUJITSU LIMITED, Kawasaki-shi (JP)

(72) Inventor: Hitoshi Ohhata, Yokohama (JP)

(73) Assignee: FUJITSU LIMITED, Kawasaki-shi (JP)

(21) Appl. No.: 16/218,544

(22) Filed: Dec. 13, 2018

(30) Foreign Application Priority Data
Jan. 19, 2018 (JP) 2018-007143

(51) Int. Cl. G06F 21/10; G06F 9/455; G06F 11/34

(52) U.S. Cl. CPC G06F 21/105; G06F 2009/45591; G06F 11/3409; G06F 9/45533

(57) ABSTRACT

An apparatus for managing a physical machine in which a virtual machine is set includes: a processor configured to execute first processing that includes managing performance information depending on performance of the physical machine, for each physical machine, the performance information being information used for calculating a license number indicating the number of licenses assigned to software to be operated on the virtual machine, execute second processing that includes outputting the performance information to a terminal, after the software has been installed on the virtual machine, and receiving license information including the license number assigned to the installed software, from the terminal, and execute third processing that includes managing software information indicating a correspondence between the license information received by the second processing, the software to which the license number included in the license information is assigned, and the virtual machine on which the software has been installed.

### CROSS-REFERENCE TO RELATED APPLICATION

This application is based upon and claims the benefit of priority of the prior Japanese Patent Application No. 2018-7143, filed on Jan. 19, 2018, the entire contents of which are incorporated herein by reference.

### FIELD

The embodiments discussed herein are related to an information processing apparatus, an information processing system, and a non-transitory computer-readable storage medium for storing a program.

### BACKGROUND

In a case where a user of a cloud service causes software to be installed on a physical server managed by a provider that provides the cloud service, or on a virtual machine assigned to the physical server, it is desirable that the license of the software is properly managed. For example, in a case where a virtual machine is assigned to a physical server, the virtual machine is assigned to a physical server in which the number of desired licenses of software used in the virtual machine is smaller than those in other physical servers. Thus, the number of consumed licenses is reduced, and the license is efficiently used.

A site of providing software communicates with a site of a user who uses the software, and thus manages the number of used licenses of the software to be equal to or smaller than the number of purchased licenses. Thus, the license is properly managed even in a case where the virtual machine is moved or duplicated.

A physical machine capable of operating the software and a physical machine capable of creating a virtual machine are specified based on a request to create the virtual machine. Then, a physical machine to generate the virtual machine is determined among the specified physical machines. Thus, operational cost of the cloud service is reduced.

Examples of the related art include Japanese Laid-open Patent Publication No. 2016-15097, International Publication Pamphlet No. WO2015/087444, and Japanese Laid-open Patent Publication No. 2015-103094

### SUMMARY

According to an aspect of the embodiments, an information processing apparatus for managing a physical machine in which a virtual machine to be used by a user is set includes: a memory; and a processor coupled to the memory and configured to execute physical management processing that includes managing performance information depending on performance of the physical machine, for each physical machine, the performance information being information used for calculating a license number indicating the number of licenses assigned to software to be operated on the virtual machine, execute interface processing that includes outputting the performance information to a user terminal operated by the user, after the software has been installed on the virtual machine, and receiving license information including the license number assigned to the installed software, from the user terminal, and execute virtual management processing that includes managing software information indicating a correspondence between the license information received by the interface processing, the software to which the license number included in the license information is assigned, and the virtual machine on which the software has been installed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing apparatus, an information processing system, and a program according to an embodiment;

FIG. 2 illustrates an example of an operation of the information processing system illustrated in FIG. 1;

FIG. 3 illustrates an information processing apparatus, an information processing system, and a program according to another embodiment;

FIG. 4 illustrates an example of a virtual machine set in a physical server illustrated in FIG. 3;

FIG. 5 illustrates an example of a license number desired for operating software installed on the virtual machine illustrated in FIG. 4;

FIGS. 6A and 6B illustrate an example of various tables included in a table group illustrated in FIG. 3;

FIGS. 7A and 7B illustrate an outline of an operation of the information processing system illustrated in FIG. 3;

FIG. 8 illustrates an example of an operation of a physical management unit illustrated in FIG. 3;

FIG. 9 illustrates an example of an operation of an image management unit illustrated in FIG. 3;

FIGS. 10A and 10B illustrate an example of a state of the information processing system after the operation illustrated in FIG. 9 has been performed by the image management unit;

FIG. 11 illustrates an example of an operation of a user setting management unit illustrated in FIG. 3;

FIG. 12 illustrates another example of the operation of the user setting management unit illustrated in FIG. 3;

FIG. 13 illustrates still another example of the operation of the user setting management unit illustrated in FIG. 3;

FIG. 14 illustrates an example of an operation of a movement management unit illustrated in FIG. 3;

FIG. 15 illustrates another example of the virtual machine set in the physical server illustrated in FIG. 3;

FIG. 16 illustrates an example of whether or not moving the virtual machine illustrated in FIG. 15 is possible;

FIG. 17 illustrates an example of an operation of an overall management unit illustrated in FIG. 3 when a CPU of the physical server is added;

FIG. 18 illustrates an example of a process of Step S610 illustrated in FIG. 17;

FIG. 19 illustrates an example of the operation of the overall management unit illustrated in FIG. 3 when the CPU of the physical server is removed;

FIG. 20 illustrates an example of a process of Step S710 illustrated in FIG. 19;

FIG. 21 illustrates an example of the operation of the overall management unit illustrated in FIG. 3 when a vCPU in the virtual machine is added;

FIG. 22 illustrates an example of the operation of the overall management unit illustrated in FIG. 3 when the vCPU of the virtual machine is removed;

FIG. 23 illustrates an information processing apparatus, an information processing system, and a program according to still another embodiment;

FIGS. 24A and 24B illustrate an example of various tables included in a table group illustrated in FIG. 23;

FIG. 25 illustrates an example of an operation of a user setting management unit illustrated in FIG. 23;

FIG. 26 illustrates an example of an operation of a movement management unit illustrated in FIG. 23; and

FIG. 27 illustrates an example of a hardware configuration of the management server illustrated in FIGS. 1, 3, and 23.

### DESCRIPTION OF EMBODIMENTS

A license number desired for software may be determined depending on performance of a physical server such as the number of central processing units (CPUs) provided in the physical server or the number of CPU cores. In this case, the license of software installed on a virtual machine by a user may be violated by the virtual machine moving between physical servers. However, in a case where a management server or the like that manages physical servers does not manage license information including the license number of software, which depends on the performance of the physical server, it is difficult to suppress an occurrence of violating the license.

In one aspect, an object of the embodiments is to manage license information depending on performance of a physical machine, in software installed on a virtual machine by a user.

Hereinafter, embodiments will be described with reference to the drawings.

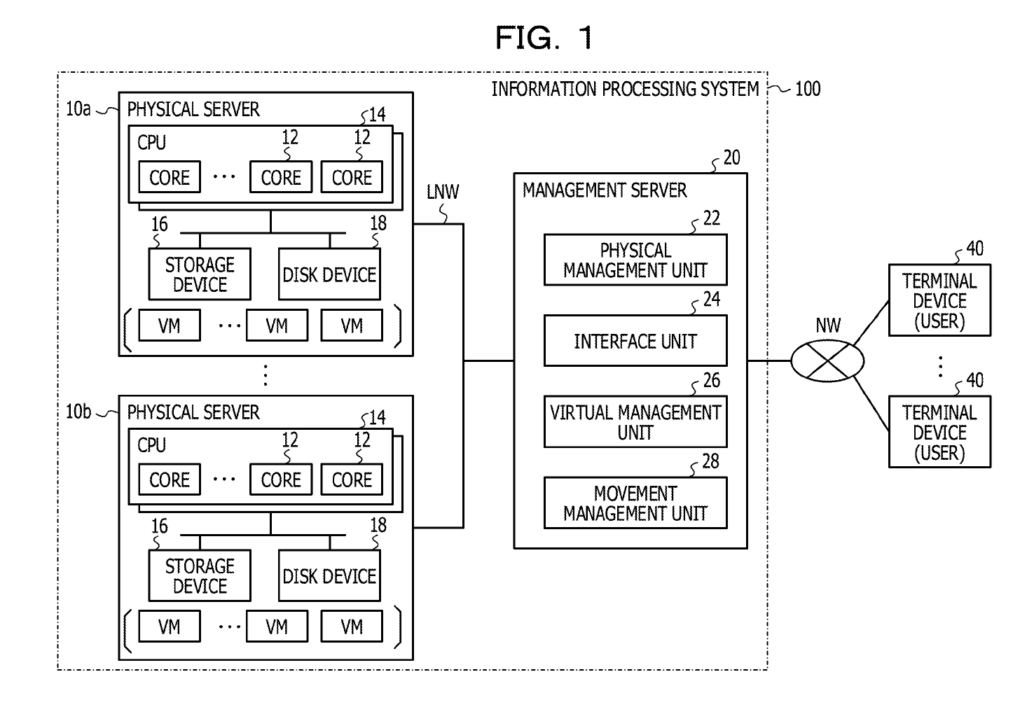

FIG. 1 illustrates an information processing apparatus, an information processing system, and a program according to an embodiment. An information processing system 100 illustrated in FIG. 1 is used, for example, in a cloud service that provides computer resources via a network NW. Although being not particularly limited, infrastructure as a service (IaaS) is provided as the cloud service.

The information processing system 100 includes a plurality of physical servers 10 (10a and 10b) capable of operating a plurality of virtual machines VM executing information processing, and a management server 20 that manages the physical server 10 used for realizing the cloud service and the like. The physical server 10 is an example of a physical machine. The management server 20 is an example of an information processing apparatus. For example, the physical server 10 and the management server 20 are coupled to each other via a network LNW.

The physical server 10 includes a CPU 14, a storage device 16, and a disk device 18. The CPU 14 includes a plurality of CPU cores 12. The storage device and the disk device are coupled to the CPU 14. The storage device 16 includes, for example, a memory module including a plurality of synchronous dynamic random access memories (SDRAMs). The disk device 18 includes a hard disk drive (HDD), a solid state drive (SSD), or the like. The physical server 10 executes a control program such as a hypervisor, which is stored in the storage device 16 and realizes a virtual machine, based on an instruction from the management server 20. If the control program is executed, physical resources such as the CPU core 12, the storage device 16, and the disk device 18 are split as virtual resources, and operate as a virtual machine VM. For example, virtual resources include a virtual CPU (vCPU which will be described later) obtained by virtualizing the CPU core 12, a virtual storage device obtained by virtualizing the storage device 16, and a virtual disk device obtained by virtualizing the disk device 18.

The management server 20 is coupled to a terminal device 40 operated by a user who uses the virtual machine VM, via the network NW such as the Internet or an intranet. The terminal device 40 is an example of a user terminal. The management server 20 includes a physical management unit 22, an interface unit 24, a virtual management unit 26, and a movement management unit 28.

The physical management unit 22 detects the physical server 10 managed by the management server 20, acquires performance information depending on performance of a CPU and the like from the detected physical server 10, and manages the acquired performance information for each physical server 10.

After software has been installed on a virtual machine VM by a user, the interface unit 24 outputs performance information of a physical server 10 in which the virtual machine VM used by the user has been set, to a terminal device 40 operated by the user. For example, the interface unit 24 performs an inquiry from the physical management unit 22 so as to acquire performance information of the physical server 10. After outputting the performance information of the physical server 10, the interface unit 24 receives license information from the terminal device 40. The license information includes a license number assigned to the software installed on the virtual machine VM used by the user. For example, the license information of the license number and the like is calculated by a user, based on the performance information received by a terminal device 40.

The virtual management unit 26 manages software information for each terminal device 40 (user). The software information indicates correspondence between the license information received by the interface unit 24, the software installed by the user, and the virtual machine VM on which the software has been installed. The virtual management unit 26 may detect software of which the license information is not managed among pieces of software provided in the virtual machine VM, and may urge the user who possesses the detected software to input the license information via the interface unit 24.

In a case where a movement factor causing the virtual machine VM to move between physical servers 10 occurs, the movement management unit 28 determines whether or not the virtual machine VM may move, based on the software information managed by the virtual management unit 26. That is, in a case where the virtual machine VM is moved between the physical servers 10, the movement management unit 28 manages whether or not the license of software provided in the virtual machine VM is in a violated state. The movement factor of the virtual machine VM occurs, for example, by maintenance of the physical server 10 or addition of a CPU in the physical server 10.

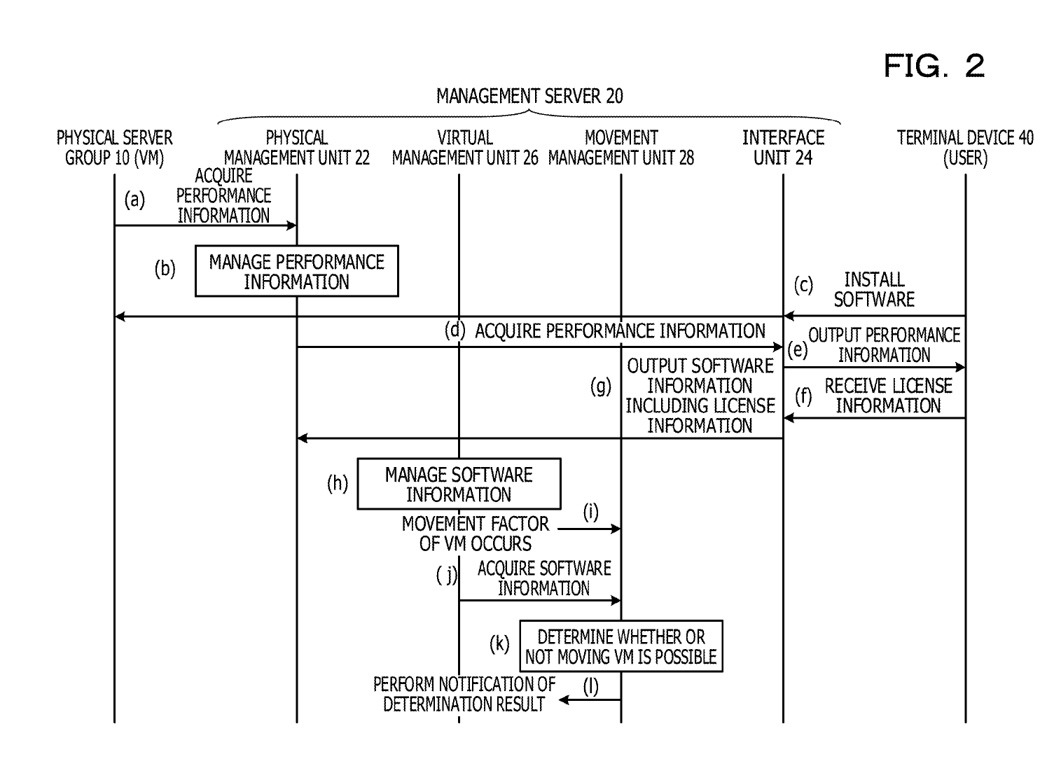

The physical management unit 22, the interface unit 24, the virtual management unit 26, and the movement management unit 28 are realized in a manner that a processor (not illustrated) such as a CPU, which is provided in the management server 20, executes a program stored in a storage unit (not illustrated). The physical management unit 22, the interface unit 24, the virtual management unit 26, and the movement management unit 28 may be realized by hardware such as a field-programmable gate array (FPGA), which is provided in the management server 20. Functions of the physical management unit 22, the interface unit 24, the virtual management unit 26, and the movement management unit 28 will be described with reference to FIG. 2.

FIG. 2 illustrates an example of the information processing system 100 illustrated in FIG. 1. Among operations illustrated in FIG. 2, an operation of the management server 20 is an example of an information processing method by the management server 20 and processing by a program executed by the management server 20. In FIG. 2, a virtual machine VM to be used by a predetermined user is set in a physical server group including a plurality of physical servers 10, in advance.

The physical management unit 22 acquires performance information from the physical server 10 managed by the management server 20 and manages the acquired performance information for each physical server 10 ((a) and (b) in FIG. 2). For example, the physical management unit 22 manages the performance information by storing the performance information in the storage unit provided in the management server 20.

The interface unit 24 transfers software to be installed on the virtual machine VM by the user, to a physical server 10 including a virtual machine VM as an installation target, via the terminal device 40. Thus, the software is installed on the virtual machine VM ((c) in FIG. 2). For example, the interface unit 24 holds information indicating the software, the virtual machine VM on which the software has been installed, and the physical server 10 including the virtual machine VM on which the software has been installed, based on the installation of the software. Information indicating a relation between the virtual machine VM and the physical server 10 including the virtual machine VM may be managed by a setting management unit (not illustrated) that controls creation of the virtual machine VM in the physical server 10, in the management server 20.

Then, the interface unit 24 acquires performance information of the physical server 10 including the virtual machine VM on which the software has been installed, from the physical management unit 22 ((d) in FIG. 2). The interface unit 24 outputs the acquired performance information to the terminal device 40 operated by the user who has caused the software to be installed ((e) in FIG. 2). Then, the interface unit 24 receives license information including a license number assigned to the installed software, from the user via the terminal device 40 ((f) in FIG. 2). The interface unit 24 outputs software information to the virtual management unit 26 ((g) in FIG. 2). The software information indicates the received license information, the software corresponding to the license information, the virtual machine VM on which the software has been installed, and the physical server 10 including the virtual machine VM.

The virtual management unit 26 manages the software information received from the interface unit 24 ((h) in FIG. 2). The virtual management unit 26 may receive only the license information from the interface unit 24 and acquire information indicating correspondence between the software, the virtual machine VM, and the physical server 10 from the physical server 10. The information indicating the correspondence between the software, the virtual machine VM, and the physical server 10 may be held in the storage unit provided in the management server 20. In this case, the virtual management unit 26 receives only the license information from the interface unit 24, and acquires the information (indicating the correspondence between the software, the virtual machine VM, and the physical server 10) from the storage unit provided in the management server 20.

As described above, the management server 20 performs an inquiry from the user via the terminal device 40 so as to acquire the license information which is information regarding the software installed by the user and changes depending on the physical server 10 on which the installation is performed. The management server 20 manages the acquired license information along with the information indicating the correspondence between the software, the virtual machine on which the software has been installed, and the physical server 10 including the virtual machine VM, as the software information. Thus, even in a case where the license number of software installed on a virtual machine VM varies by performance of a physical server 10 including the virtual machine VM, the management server 20 may manage the software information including the license number by performing an inquiry from the user.

The movement management unit 28 operates, for example, in a case where the movement management unit 28 has received a notification indicating that the movement factor of the virtual machine VM has occurred, from a terminal device operated by a manager of the management server 20 ((i) in FIG. 2). The movement management unit 28 acquires software information corresponding to software included in the virtual machine VM moving between physical servers 10, from the virtual management unit 26 based on the occurrence of the movement factor ((j) in FIG. 2). The movement management unit 28 determines whether or not moving the virtual machine VM is possible, based on the acquired software information. Then, the movement management unit notifies, for example, the terminal device operated by the manager of the management server 20 of a determination result ((l) and (k) in FIG. 2).

For example, in a case where performance of the physical server 10 as the movement destination of the virtual machine VM is lower than performance of the physical server 10 as the movement source of the virtual machine VM, the license of the software installed in the virtual machine VM is not violated by moving of the virtual machine VM. In this case, the movement management unit 28 determines that moving the virtual machine VM is possible. In a case where the performance of the physical server 10 as the movement destination of the virtual machine VM is higher than the performance of the physical server 10 as the movement source of the virtual machine VM, the license of the software installed in the virtual machine VM is violated by moving of the virtual machine VM. In this case, the movement management unit 28 determines that moving the virtual machine VM is not possible.

As described above, since software information including a license number desired for software installed on a virtual machine VM by a user is used, it is possible to determine whether or not moving the virtual machine VM on which the software has been installed by the user is possible. In other words, even in a case where the license number of software installed on a virtual machine VM varies by performance of a physical server 10 including the virtual machine VM, it is possible to determine whether or not moving the virtual machine VM is possible.

As described above, in the embodiment illustrated in FIGS. 1 and 2, it is possible to manage software information which is information regarding software installed by a user and includes a license number which changes depending on a physical server 10 in which the software is installed. Thus, for example, in a case where a virtual machine VM moves between physical servers 10 having different performance, it is possible to determine whether or not license of software installed on the virtual machine VM is violated by moving of the virtual machine VM. That is, it is possible to determine whether or not moving the virtual machine VM is possible.

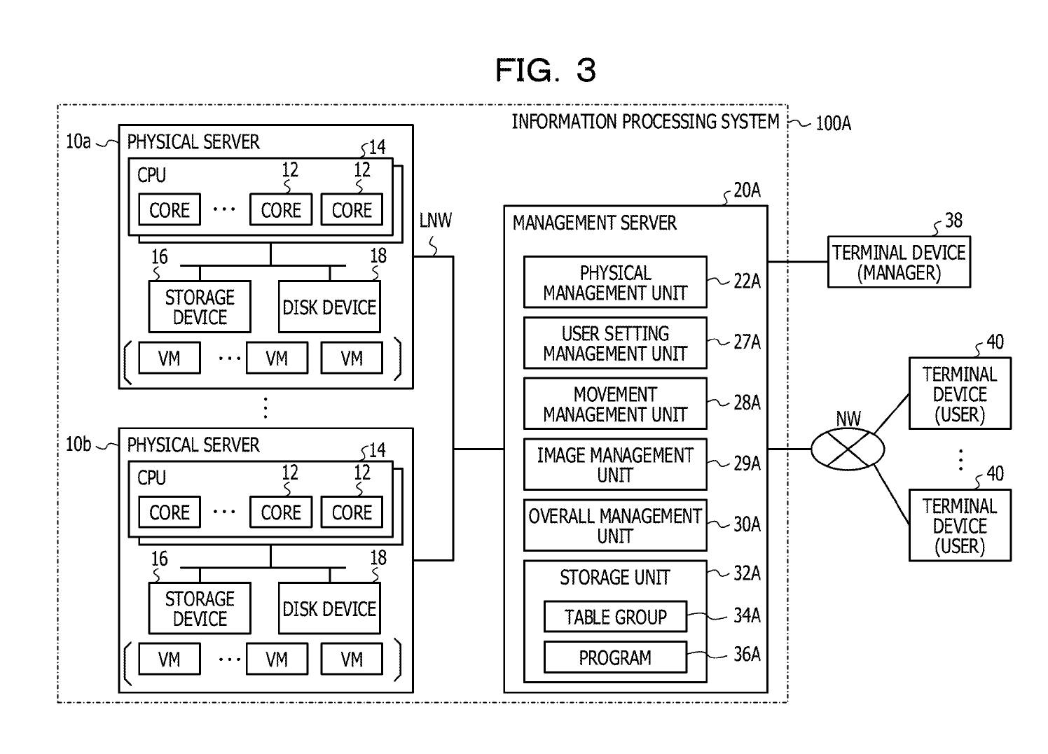

FIG. 3 illustrates an information processing apparatus, an information processing system, and a program according to another embodiment. Regarding the same or similar components as or to those in the information processing system 100 illustrated in FIG. 1, detailed descriptions will not be repeated. An information processing system 100A illustrated in FIG. 3 has a configuration similar to that of the information processing system 100 illustrated in FIG. 1 except that a management server 20A is provided instead of the management server 20. The information processing system 100A is used for providing a cloud service such as an infrastructure as a service (IaaS). The cloud service realized by the information processing system 100A may be any of a private cloud and a public cloud.

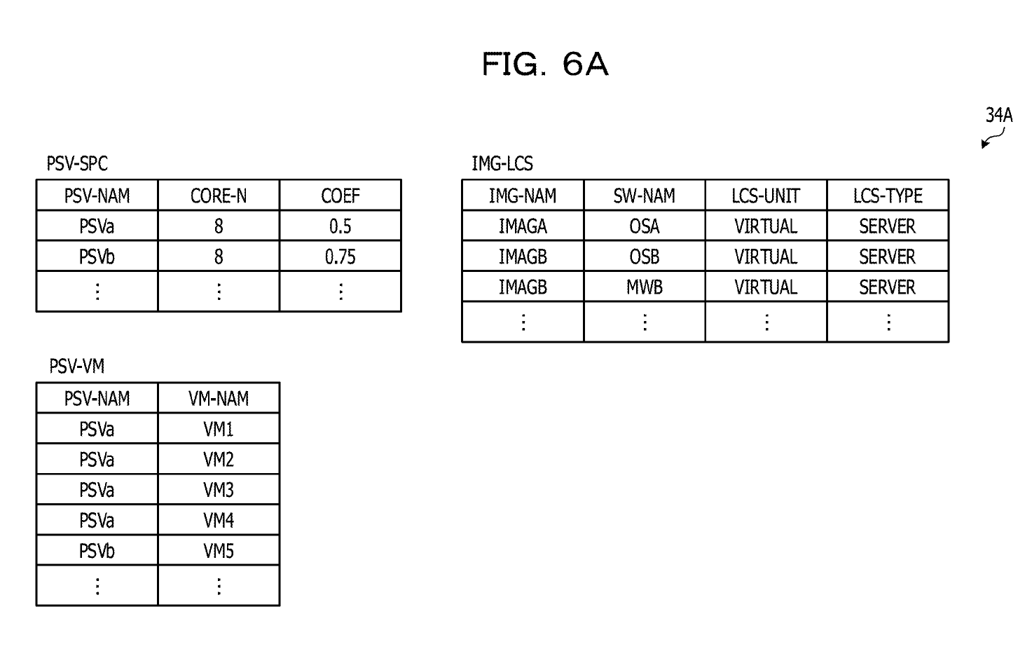

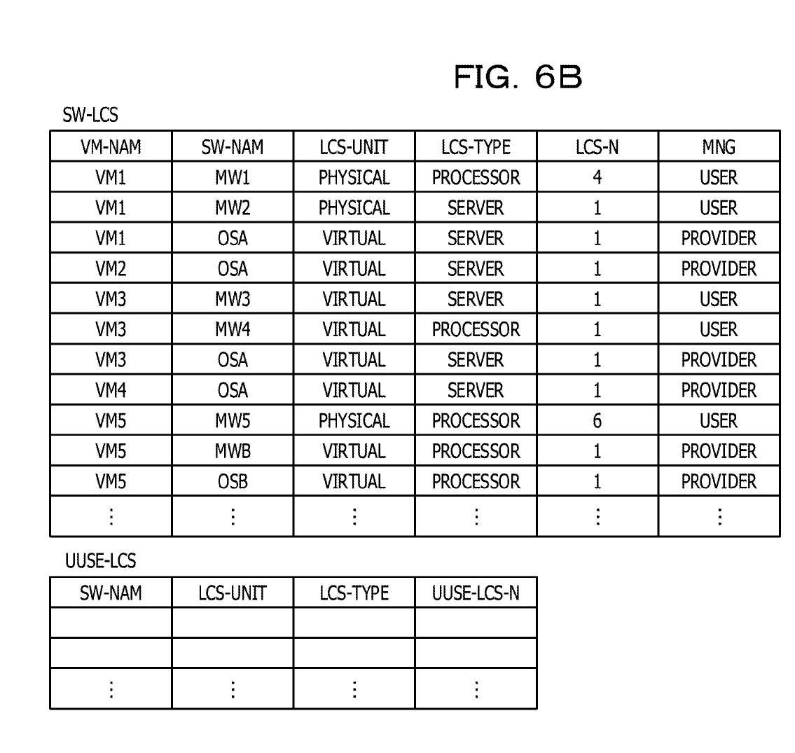

The management server 20A includes a physical management unit 22A, a user setting management unit 27A, a movement management unit 28A, an image management unit 29A, an overall management unit 30A, and a storage unit 32A. The storage unit 32A has a storage area allocated to a table group 34A including various tables used for managing virtual machine set by a user and managing the license of software to be installed on a virtual machine VM. The storage unit 32A has a storage area in which a program 36A executed for managing a virtual machine is stored. FIG. 6 (i.e. FIGS. 6A and 6B) illustrates an example of the table group 34A.

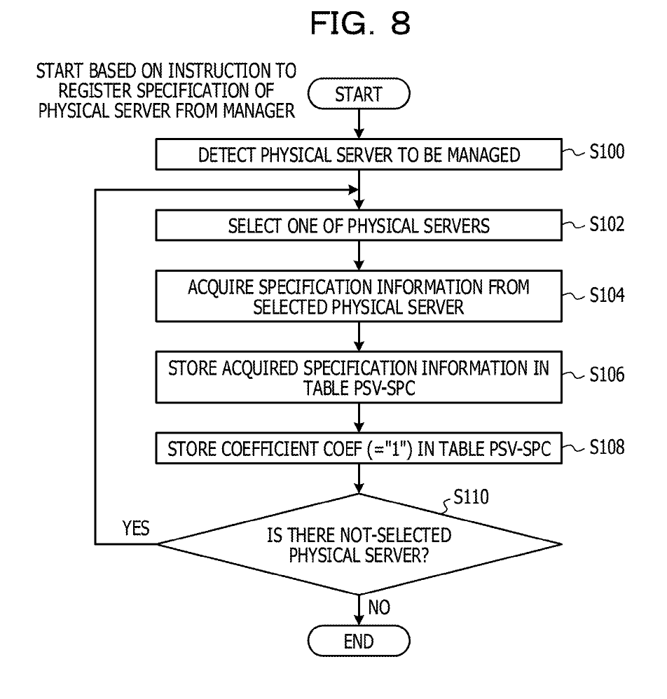

The physical management unit 22A detects a physical server 10 managed by the management server 20A and acquires specifications of a CPU and the like from the detected physical server 10. The physical management unit 22A stores specification information indicating the acquired specifications, in a predetermined table of the table group 34A. Thus, the user setting management unit 27A, the movement management unit 28A, the image management unit 29A, and the overall management unit 30A may acquire specifications of the physical server 10 as a management target, by referring to the table group 34A. FIG. 8 illustrates an example of an operation of the physical management unit 22A.

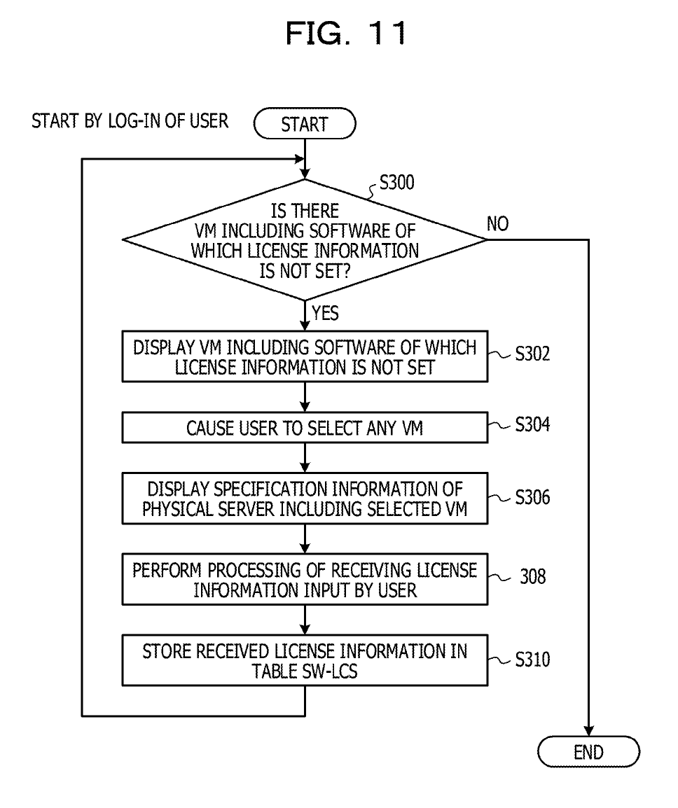

The user setting management unit 27A detects software of which license information has not been set in the table group 34A among pieces of software provided in the virtual machine VM. Then, the user setting management unit urges a user (terminal device 40) who possesses the detected software to input license information. The user setting management unit 27A stores the license information input by the user, in the table group 34A. In a case where the virtual machine VM is deleted from the physical server 10, the user setting management unit 27A deletes information which corresponds to the deleted virtual machine VM and has been held in table group 34A. FIGS. 11 to 13 illustrate an example of an operation of the user setting management unit 27A.

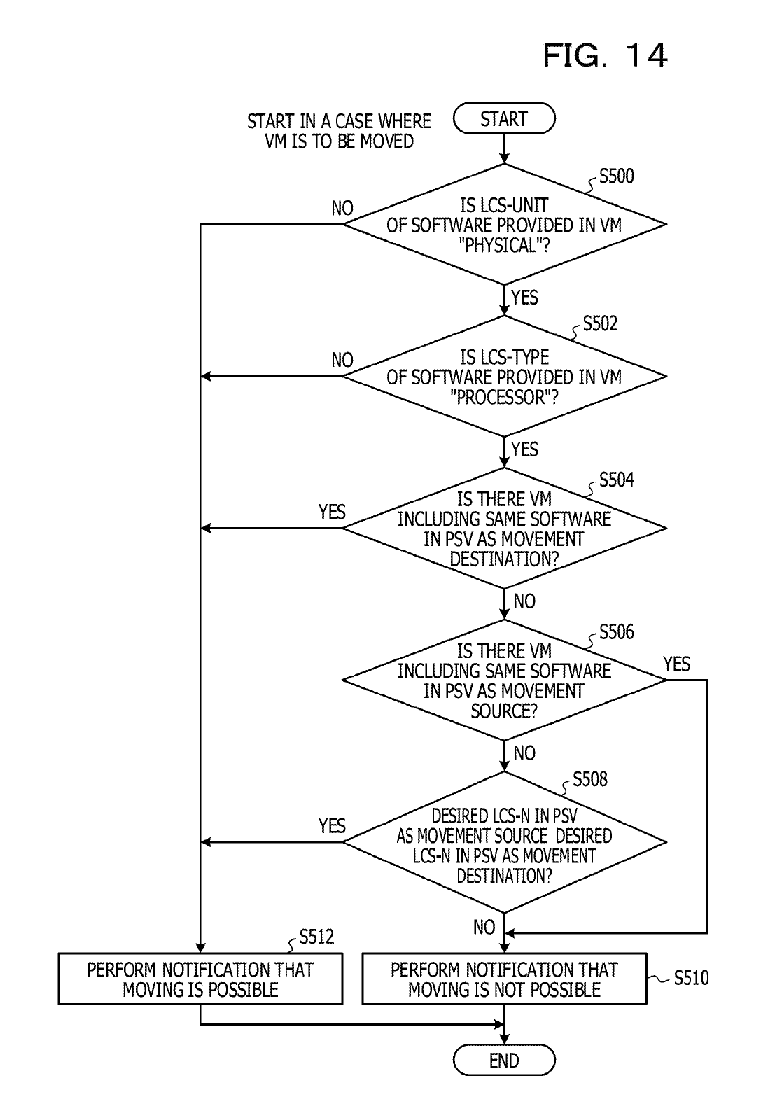

In a case where the virtual machine VM is moved between physical servers 10, the movement management unit 28A manages whether or not moving the virtual machine VM is possible, based on the information held in the table group 34A. That is, in a case where the virtual machine VM is moved between physical servers 10, the movement management unit 28A manages whether or not the license of software included in the virtual machine VM is in a violated state. FIG. 14 illustrates an example of an operation of the movement management unit 28A.

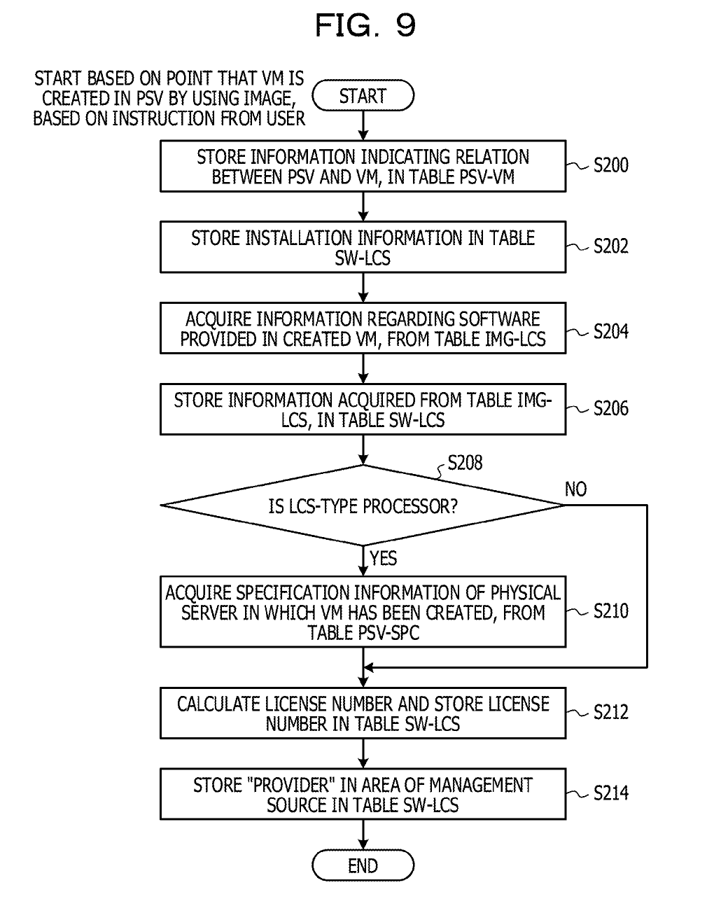

The image management unit 29A operates in a case where a virtual machine VM has been created in the physical server 10 by using a VM image which is a template of the virtual machine VM, which has been prepared in advance. The VM image is an example of an image including configuration data of a virtual machine VM and program data of software to be set in the virtual machine VM. The image management unit 29A stores information of the virtual machine VM created in the physical server 10 based on the VM image and information of the software included in the virtual machine VM, in a predetermined table of the table group 34A. The information stored in the table includes the license information of the software. Thus, for example, in a case where the virtual machine VM created in the physical server 10 by using the VM image is moved to another physical server 10, it is possible to determine whether or not the license of software included in the virtual machine VM is violated, by referring the license information. FIG. 9 illustrates an example of an operation of the image management unit 29A.

The overall management unit 30A manages creation of a virtual machine VM into a physical server 10, manages deletion of a virtual machine VM from a physical server 10, and manages moving of a virtual machine VM between physical servers 10. The overall management unit 30A manages addition or removal of a CPU of a physical server 10 and addition or removal of a vCPU of a virtual machine VM. The overall management unit 30A that manages addition of a CPU and a vCPU is an example of an addition management unit.

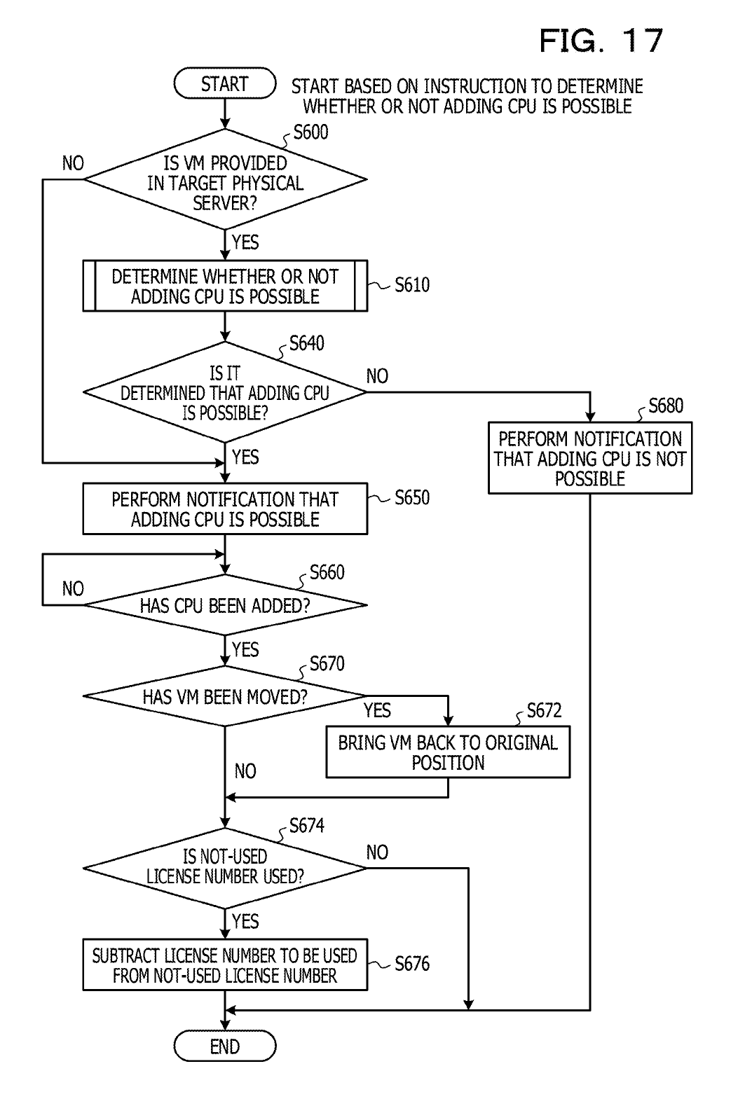

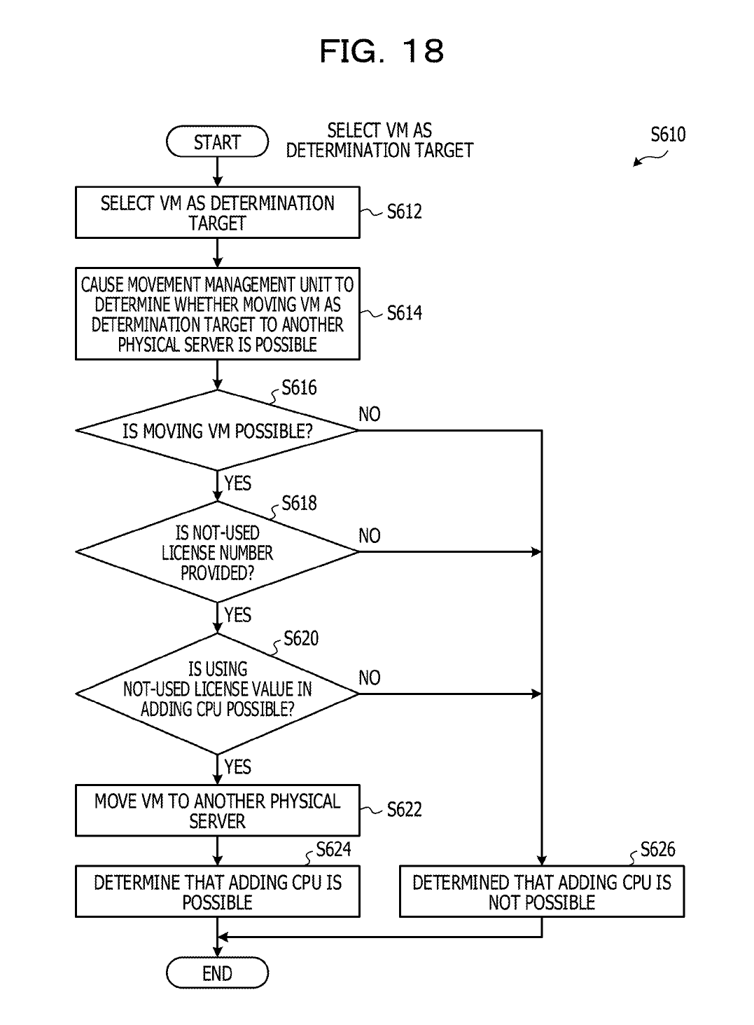

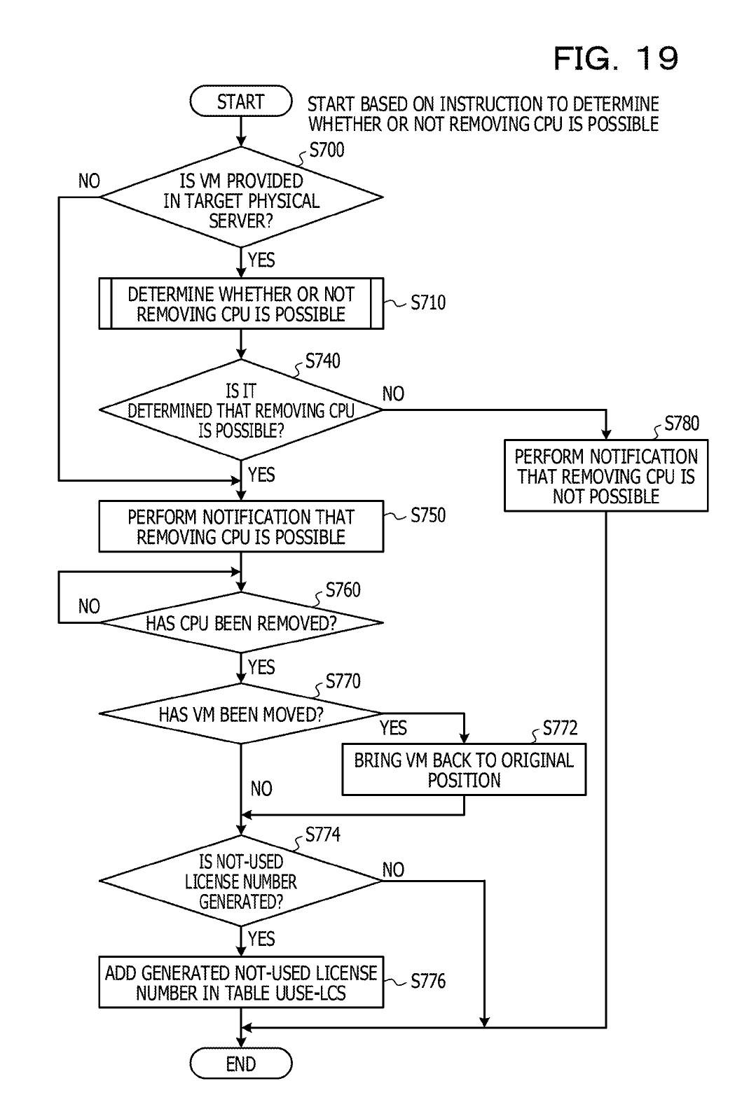

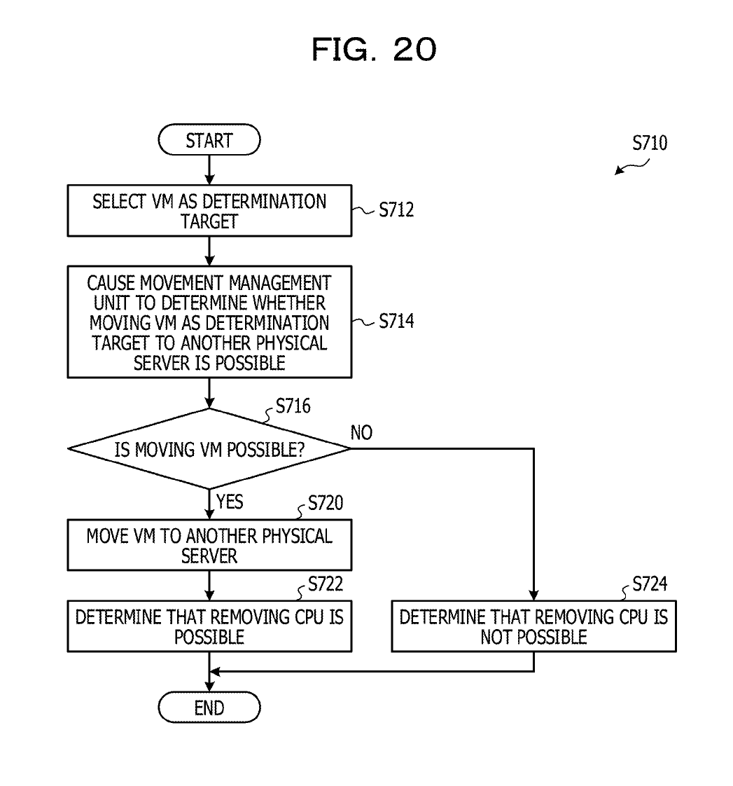

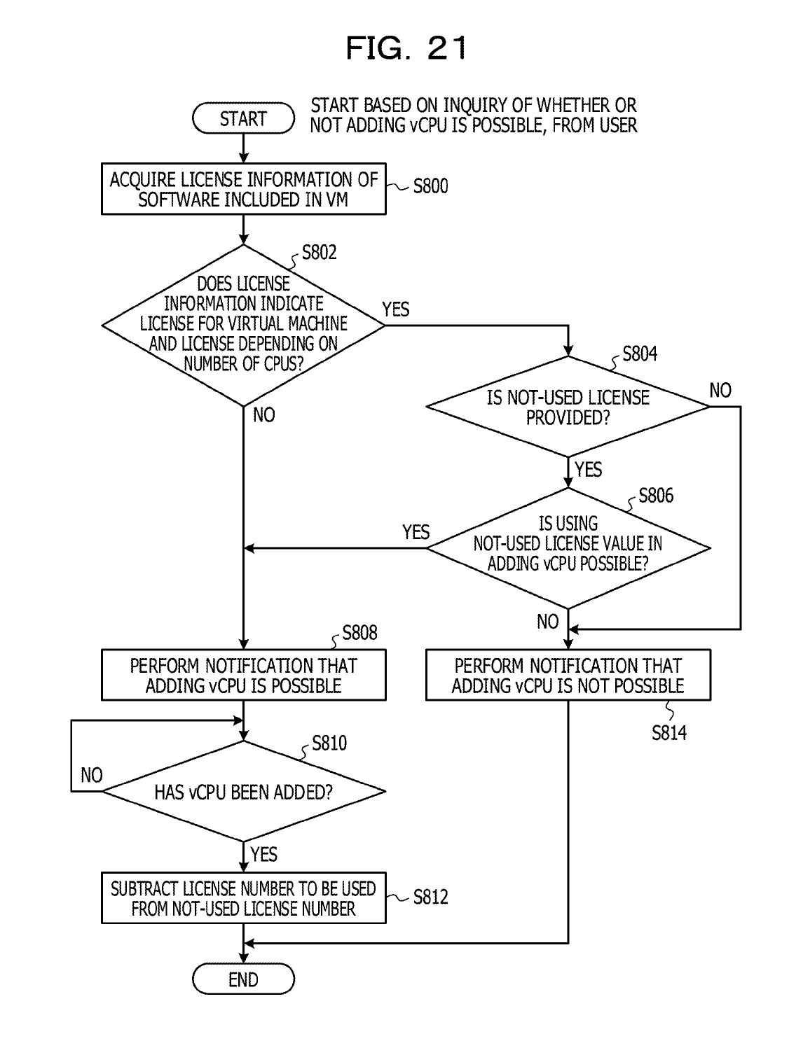

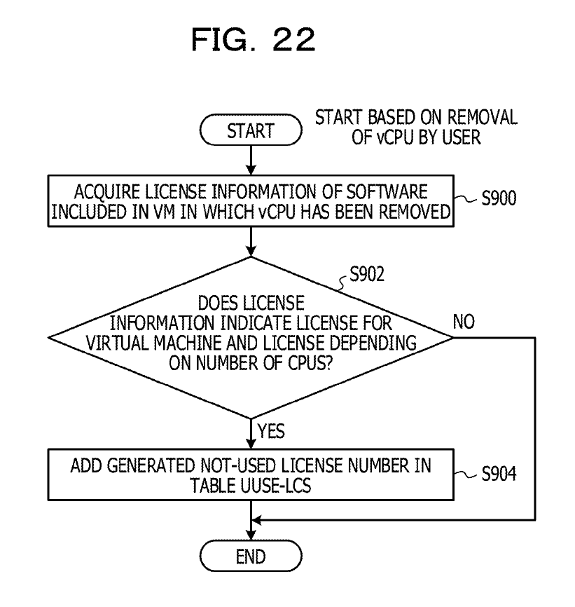

FIGS. 17 and 18 illustrate an example of an operation of the overall management unit 30A that manages addition of a CPU. FIGS. 19 and 20 illustrate an example of an operation of the overall management unit 30A that manages removal of a CPU. FIG. 21 illustrates an example of an operation of the overall management unit 30A that manages addition of a vCPU. FIG. 22 illustrates an example of an operation of the overall management unit 30A that manages removal of a vCPU.

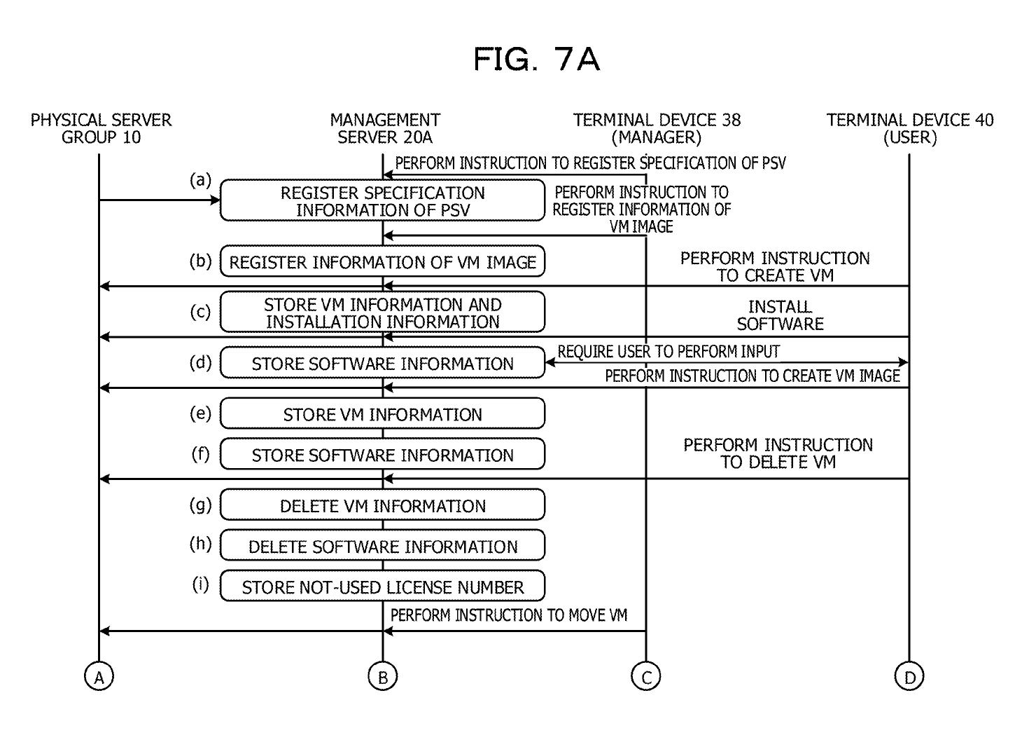

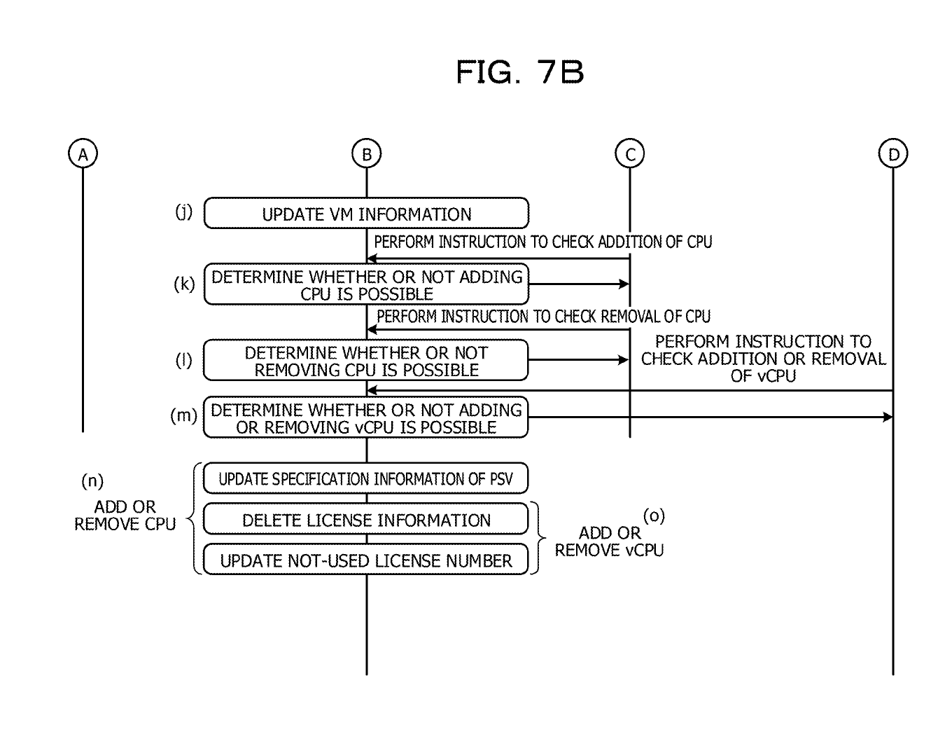

The physical management unit 22A, the user setting management unit 27A, the movement management unit 28A, the image management unit 29A, and the overall management unit 30A are realized in a manner that the processor such as the CPU, which is provided in the management server 20A executes the program 36A. The physical management unit 22A, the user setting management unit 27A, the movement management unit 28A, the image management unit 29A, and the overall management unit 30A may be realized by hardware such as an FPGA, which is provided in the management server 20A. Functions of the physical management unit 22A, the user setting management unit 27A, the movement management unit 28A, the image management unit 29A, and the overall management unit 30A will be described with reference to FIG. 7.

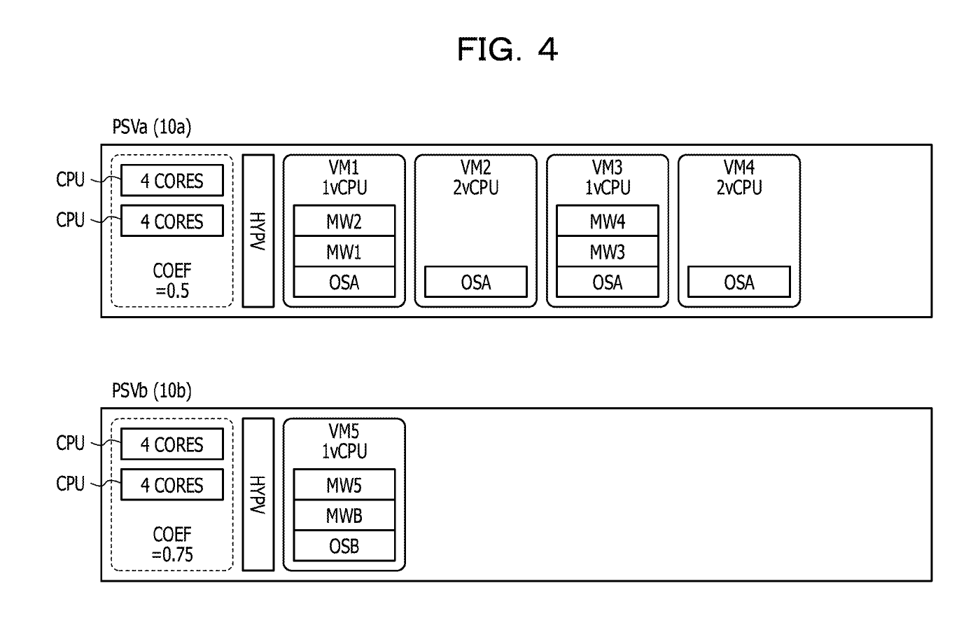

FIG. 4 illustrates an example of a virtual machine VM set in the physical server 10 illustrated in FIG. 3. In the following descriptions, a physical server 10a will be described as a physical server PSVa, and a physical server 10b will be described as a physical server PSVb. The number of physical servers PSV which are physical servers PSV provided in the information processing system 100A and are managed by the management server 20A is not limited to two.

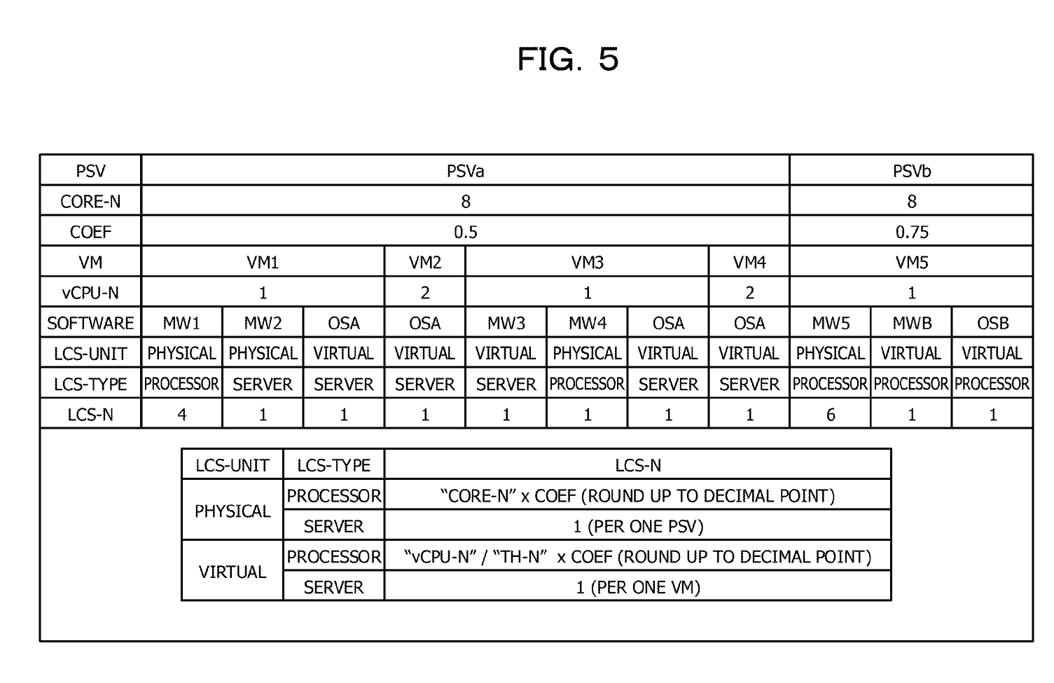

Each of the physical servers PSVa and PSVb includes two CPUs 14 each including four CPU cores 12. Processing performance of the CPU 14 of the physical server PSVb is higher than processing performance of the CPU 14 of the physical server PSVa. Therefore, a method of calculating a license number desired for operating software installed on a virtual machine VM differs between the physical servers PSVa and PSVb. A coefficient COEF used for calculating the license number is “0.5” in a case of the physical server PSVa and “0.75” in a case of the physical server PSVb. FIG. 5 illustrates an example of the method of calculating the license number. In the following descriptions, the CPU 14 is also referred to as a CPU, and the CPU core 12 is also referred to as a core.

Each of the physical servers PSVa and PSVb executes, for example, a hypervisor HYPV so as to control creation, movement, deletion, and the like of a virtual machine VM. In the example illustrated in FIG. 4, the physical server PSVa includes four virtual machines VM1, VM2, VM3, and VM4, and the physical server PSVb includes one virtual machine VMS.

One virtual CPU (1 vCPU) is assigned to the virtual machine VM1. The virtual machine VM1 includes an operating system OSA and software MW1 and MW2. Two virtual CPUs (2 vCPUs) are assigned to the virtual machine VM2. The virtual machine VM2 includes an operating system OSA. One virtual CPU (1 vCPU) is assigned to the virtual machine VM3. The virtual machine VM3 includes an operating system OSA and software MW3 and MW4. Two virtual CPUs (2 vCPUs) are assigned to the virtual machine VM4. The virtual machine VM4 includes an operating system OSA. One virtual CPU (1 vCPU) is assigned to the virtual machine VMS. The virtual machine VM5 includes an operating system OSB and software MWB and MWS. In the following descriptions, the virtual CPU is also referred to as a vCPU.

FIG. 5 illustrates an example of a license number LCS-N desired for operating software installed on the virtual machine VM illustrated in FIG. 4. The license number LCS-N desired for operating each piece of software is determined based on a purchase unit LCS-UNIT of a license, a license type LCS-TYPE thereof, and processing performance of a core for operating the software.

As the purchase unit LCS-UNIT of a license, “physical” indicating a purchase in a unit of a physical server (PSV) and “virtual” indicating a purchase in a unit of a virtual machine (VM) are provided. As the license type LCS-TYPE, a processor license (“processor”) having a license number which is determined in accordance with the number of processors (CPUs) and a server license (“server”) having a license number which is determined in accordance with the number of servers on which software is installed are provided.

In addition, as the license type LCS-TYPE, a user license having a license number which is determined in accordance with the number of registered users are provided. Further, as the license type LCS-TYPE, a server license-by-model class having a license number which is determined in accordance with performance (model class) of a physical server PSV on which software is installed. The purchase unit LCS-UNIT and the license type LCS-TYPE of a license are determined in advance, for each piece of software. Therefore, the license number LCS-N is determined in accordance with software and an environment of a physical server PSV on which the software is installed.

In a case where the purchase unit LCS-UNIT of a license is “physical”, and the license type LCS-TYPE of the license is “processor”, the license number LCS-N is calculated by multiplying the total number CORE-N of CPU cores provided in the physical server PSV by the coefficient COEF. In a case where the purchase unit LCS-UNIT of a license is “virtual”, and the license type LCS-TYPE of the license is “processor”, firstly, the total number vCPU-N of virtual CPUs assigned to the virtual machine VM is divided by a thread number TH-N. The license number LCS-N is calculated in a manner that a value obtained by dividing the total number vCPU-N of virtual CPUs by the thread number TH-N is multiplied by the coefficient COEF. For example, the thread number TH-N is set to “1” in a case where a hyper-threading function of dividing a core and operating the core is in an OFF state, and is set to “2” in a case where the hyper-threading function is in an ON state. In the following descriptions, a case where the hyper-threading function is in the OFF state (that is, thread number TH-N=“1”) will be described. Therefore, in a case where the purchase unit LCS-UNIT of a license is “virtual”, and the license type LCS-TYPE of the license is “processor”, the license number LCS-N is calculated by a product of the total number vCPU-N of virtual CPUs and the coefficient COEF.

In a case where the calculated license number LCS-N includes decimal places, the decimal places are rounded up. In a case where the license type LCS-TYPE is a server license, and software is installed on one server, the license number LCS-N is set to “1”. The license number LCS-N of software installed on a virtual machine VM by a user is calculated by the user. In the following descriptions, the total number CORE-N of CPU cores is also referred to as the number CORE-N of cores, and the total number vCPU-N of virtual CPUs is also referred to as the number vCPU-N of cores.

FIG. 6 (i.e. FIGS. 6A and 6B) illustrates an example of various tables included in the table group 34A illustrated in FIG. 3. As illustrated in FIG. 4, the state of the table group 34A illustrated in FIG. 6 represents a state where the virtual machines VM1 to VM4 have been created in the physical server PSVa, and the virtual machine VM5 has been created in the physical server PSVb.

The table group 34A includes a table PSV-SPC in which specification information of hardware of a physical server PSV is stored and a table IMG-LCS in which license information of a VM image which has been prepared in advance by a provider providing a cloud service and the like is stored. The table group 34A includes a table PSV-VM in which VM information indicating a relation between a physical server PSV and a virtual machine VM assigned to the physical server PSV is stored. Further, the table group 34A includes a table SW-LCS in which license information of software installed on a virtual machine VM is stored and a table UUSE-LCS in which license information of not-used software is stored.

The table PSV-SPC has a plurality of records including regions in which a server name PSV-NAM of a physical server PSV, the number CORE-N of cores provided in the physical server PSV, and the coefficient COEF are respectively stored. The number CORE-N of cores and the coefficient COEF are an example of performance information depending on performance of the physical server 10. In a case where a CPU provided in a physical server 10 includes one core, the number CORE-N of cores is equal to the number of CPUs.

Each record in the table PSV-SPC may have a region in which the thread number TH-N assigned to each CPU core is stored and a region in which information indicating a model class of the physical server PSV is stored. As described with reference to FIG. 5, the thread number TH-N is used for calculating a license number in a case where the purchase unit LCS-UNIT of a license is “virtual”, and the license type LCS-TYPE of the license is “processor”. The model class is used for calculating the license number in a case where the model class is a server license-by-model class having a license number which is determined in accordance with the model class of the physical server PSV.

The table IMG-LCS has a plurality of records including regions in which a VM image name IMG-NAM, a software name SW-NAM, and the purchase unit LCS-UNIT and the license type LCS-TYPE of a license are respectively stored. The VM image name IMG-NAM is a name for identifying a VM image. The software name SW-NAM is a name for identifying software included in the VM image. Information regarding a prepared VM image is input to the table IMG-LCS by the manager and the like through the terminal device 38 operated by the manager, every time the VM image is prepared by a provider and the like. The terminal device 38 is an example of a manager terminal.

The table PSV-VM has a plurality of records including regions in which a server name PSV-NAM for identifying a physical server PSV and a virtual machine name VM-NAM for identifying a virtual machine VM assigned to the physical server PSV are respectively stored.

The table SW-LCS has a plurality of records including regions in which a virtual machine name VM-NAM, a software name SW-NAM, a purchase unit LCS-UNIT, a license type LCS-TYPE, a license number LCS-N, and a management subject MNG are respectively stored.

The virtual machine name VM-NAM and the software name SW-NAM are an example of installation information. The purchase unit LCS-UNIT, the license type LCS-TYPE, and the license number LCS-N of a license are an example of license information. The purchase unit LCS-UNIT and the license type LCS-TYPE of a license are an example of first license information. The virtual machine name VM-NAM, the software name SW-NAM, and the purchase unit LCS-UNIT, the license type LCS-TYPE, and the license number LCS-N of a license are an example of software information. That is, the software information includes the installation information and the license information. The table SW-LCS in which the software information is held is an example of a software information holding unit.

In the region of the management subject MNG, information indicating a user is stored in a case of software which is purchased and managed by the user without passing through a provider. Information indicating a provider is stored in the region of the management subject, in a case of software managed by the provider. For example, software such as an OS, which is included in a VM image is managed by a provider. Thus, information indicating the provider is stored in the region of the management subject MNG. Information which indicates a user and is stored in the region of the management subject MNG includes information of, for example, an identification (ID) allowed to identify the user.

The table UUSE-LCS has a plurality of records including regions in which the software name SW-NAM, the purchase unit LCS-UNIT and the license type LCS-TYPE of a license, and a not-used license number UUSE-LCS-N are respectively stored.

FIG. 7 (i.e. FIGS. 7A and 7B illustrates an outline of an operation of the information processing system 100A illustrated in FIG. 3. In FIG. 7, the operation is not illustrated in chronological order.

In a case where the physical management unit 22A of the management server 20A has received an instruction to register specification information of a physical server PSV, from the manager via the terminal device 38, the physical management unit 22A acquires specification information regarding specifications of a physical server PSV from each physical server PSV. The physical management unit 22A registers the acquired specification information in the table PSV-SPC ((a) in FIG. 7). For example, the specification information includes the number CORE-N of cores provided in each physical server PSV, a thread number TH-N assigned to each CPU core, and a model class.

In a case where the image management unit 29A of the management server 20A has received an instruction to register information of a VM image provided for a user, from the manager via the terminal device 38, the image management unit 29A acquires information regarding the VM image from a library or the like of the VM image. The image management unit 29A registers the acquired information in the table IMG-LCS ((b) in FIG. 7). The information regarding the VM image includes a VM image name IMG-NAM, a software name SW-NAM, and a purchase unit LCS-UNIT and a license type LCS-TYPE of a license.

In a case where the overall management unit 30A of the management server 20A has received an instruction to create a virtual machine VM from the user via the terminal device 40, the overall management unit 30A instructs any physical server PSV to create a virtual machine VM. The user setting management unit 27A stores VM information in the table PSV-VM based on that the virtual machine VM has been created in the physical server 10 ((c) in FIG. 7). The VM information indicates a relation between the virtual machine VM and a physical server PSV in which the virtual machine VM has been created. The VM information includes a server name PSV-NAM and a virtual machine name VM-NAM. The user setting management unit 27A stores installation information including a virtual machine name VM-NAM and a software name SW-NAM in the table SW-LCS.

In a case where software has been installed on any virtual machine VM by the user via the terminal device 40, the user setting management unit 27A stores the installation information in the table SW-LCS. The installation information includes a virtual machine name VM-NAM of the virtual machine on which the software has been installed, and a software name SW-NAM. The user setting management unit 27A requires the user causing the software to be installed, to input license information regarding the installed software. The user setting management unit 27A stores the license information received from the user via the terminal device 40 and user information including an ID and the like allowed to identify the user, in the table SW-LCS. The user information is stored in the region of the management subject MNG in the table SW-LCS. That is, the user setting management unit 27A stores the software information including the installation information and the license information, in the table SW-LCS, based on installation of the software onto the virtual machine VM ((d) in FIG. 7). A window for requiring the user to input license information is displayed on a screen of the terminal device 40 operated by the user, for example, based on that the user has logged into the cloud service realized by the information processing system 100A.

In a case where the overall management unit 30A has received an instruction to create a virtual machine VM in a physical server PSV by using a VM image, from the user via the terminal device 40, the overall management unit 30A creates the virtual machine VM corresponding to the VM image of which an instruction has been received, in any physical server PSV. The virtual machine VM created in the physical server PSV by using the VM image includes software in the VM image. The image management unit 29A stores VM information in the table PSV-VM, based on that the virtual machine VM has been created in the physical server 10 based on the VM image ((e) in FIG. 7). The VM information indicates a relation between the virtual machine VM and the physical server PSV in which the virtual machine VM has been created.

The image management unit 29A acquires the information regarding the VM image used for creating the virtual machine VM, from the table IMG-LCS. The image management unit 29A calculates a license number desired for the software included in the VM image, based on the acquired information and the information held in the table PSV-SPC. The image management unit 29A stores installation information of the software included in the virtual machine VM created based on the VM image, in the table SW-LCS. The image management unit 29A stores software information including installation information and license information including the calculated license number, in the table SW-LCS along with information (=“provider”) indicating the management subject MNG ((f) in FIG. 7). The license information regarding the software included in the VM image is managed by a provider operating the management server 20A. Therefore, an input of license information regarding the software included in the VM image is not required to the user.

In a case where the overall management unit 30A has received an instruction to delete the virtual machine VM created in any physical server PSV, from the user via the terminal device 40, the overall management unit 30A deletes the virtual machine VM in the physical server PSV including the virtual machine VM of which the instruction has been received. The user setting management unit 27A deletes the VM information held in a record corresponding to the deleted virtual machine VM, from the table PSV-VM based on that the virtual machine VM has been deleted from the physical server 10 ((g) in FIG. 7). The user setting management unit 27A deletes information indicating the software information and the management subject MNG held in a record corresponding to the deleted virtual machine VM, from the table SW-LCS ((h) in FIG. 7). Further, in a case where the software installed on the virtual machine VM has been deleted by deleting the virtual machine VM, the user setting management unit 27A sets the license number assigned to the deleted software to be a not-used license number UUSE-LCS-N. The user setting management unit 27A stores the not-used license number UUSE-LCS-N in the table UUSE-LCS ((i) in FIG. 7).

In a case where the overall management unit 30A has received an instruction to move the virtual machine VM between physical servers PSV, from the manager via the terminal device 38, the overall management unit 30A instructs the movement management unit 28A to determine whether or not moving is possible. For example, the virtual machine VM is moved between the physical servers PSV, in a case where maintenance of the physical server PSV, addition or removal of a CPU in the physical server PSV, or the like is performed.

The movement management unit 28A determines whether or not moving the virtual machine VM is possible, based on the instruction from the overall management unit 30A, and notifies the overall management unit 30A of a determination result. In a case where the determination result indicates that moving is possible, the overall management unit 30A instructs a physical server PSV as a movement source and a physical server PSV as a movement destination of movement of the virtual machine VM. The user setting management unit 27A updates the VM information held in the table PSV-VM based on that the virtual machine VM has been moved ((j) in FIG. 7).

In a case where the overall management unit 30A has received an instruction to check whether or not adding a CPU in any physical server PSV is possible, from the manager via the terminal device 38, the overall management unit 30A refers to information held in the tables PSV-VM, SW-LCS, and UUSE-LCS. The overall management unit 30A determines whether or not adding a CPU is possible, and notifies the terminal device 38 of a determination result ((k) in FIG. 7)

In a case where the overall management unit 30A has received an instruction to check whether or not removing a CPU in any physical server PSV is possible, from the manager via the terminal device 38, the overall management unit 30A refers to information held in the tables PSV-VM and SW-LCS. The overall management unit 30A determines whether or not removing a CPU is possible, and notifies the terminal device 38 of a determination result ((l) in FIG. 7).

In a case where the overall management unit 30A has received an instruction to check whether or not adding a vCPU in any virtual machine VM, from the user via the terminal device 40, the overall management unit 30A refers to information held in the tables SW-LCS and UUSE-LCS. In a case where the overall management unit 30A has received an instruction to check whether or not removing a vCPU in any virtual machine VM, from the user via the terminal device 40, the overall management unit 30A refers to information held in the table SW-LCS. The overall management unit 30A determines whether or not adding or removing a vCPU is possible, and notifies the terminal device 40 of a determination result ((m) in FIG. 7).

In a case where a CPU has been added in any physical server PSV based on the determination result indicating that adding a CPU is possible, the overall management unit 30A updates the tables PSV-SPC, SW-LCS, and UUSE-LCS. In a case where a CPU in any physical server PSV has been removed based on the determination result indicating that removing a CPU is possible, the overall management unit 30A updates the tables PSV-SPC, SW-LCS, and UUSE-LCS ((n) in FIG. 7).

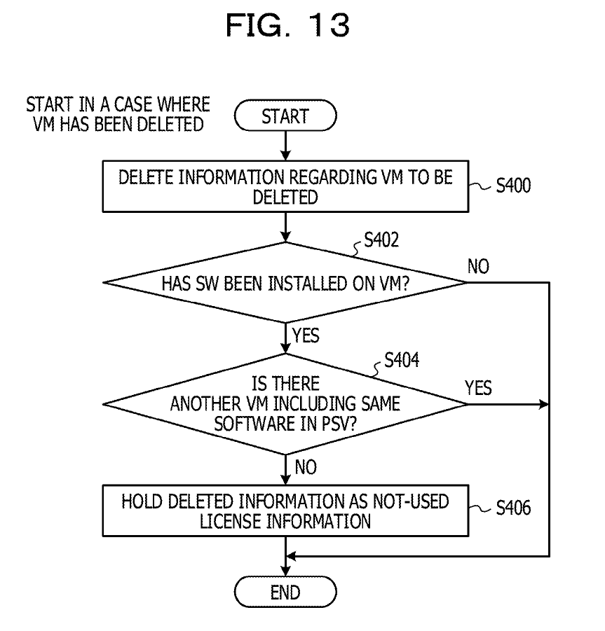

In a case where a vCPU has been added in any virtual machine VM based on the determination result indicating that adding a vCPU is possible, the overall management unit 30A updates the tables SW-LCS and UUSE-LCS. In a case where a vCPU in any virtual machine VM has been removed, the overall management unit 30A updates the tables SW-LCS and UUSE-LCS ((o) in FIG. 7). The tables PSV-SPC, SW-LCS, and UUSE-LCS may be updated by the user setting management unit 27A based on the instruction from the overall management unit 30A. FIG. 8 illustrates an example of updating the table PSV-SPC. FIGS. 9 and 11 illustrate an example of updating the table SW-LCS. FIG. 13 illustrates an example of updating the table UUSE-LCS.

FIG. 8 illustrates an example of the operation of the physical management unit 22A illustrated in FIG. 3. That is, FIG. 8 illustrates an example of an information processing method by the management server 20A and a program executed by the management server 20A. The operation illustrated in FIG. 8 is started in a case where an instruction to register specification information of a physical server PSV in the table PSV-SPC has been issued from the manager to the management server 20A via the terminal device 38.

Firstly, in Step S100, the physical management unit 22A detects a physical server PSV coupled via the network LNW, as a physical server PSV to be managed. In Step S102, the physical management unit 22A selects one of physical servers PSV detected in Step S100. In Step S104, the physical management unit 22A acquires specification information from the physical server PSV selected in Step S102. For example, the specification information acquired from the physical server PSV corresponds to the number CORE-N of cores, a thread number TH-N assigned to each CPU core, and a model class.

Then, in Step S106, the physical management unit 22A stores the acquired specification information in the table PSV-SPC along with a server name PSV-NAM for identifying the physical server PSV. In Step S108, the physical management unit 22A stores the default value (=“1”) of the coefficient COEF in the table PSV-SPC. The default value of the coefficient COEF is the maximum value of the coefficient COEF which may be set. The coefficient COEF is determined based on processing performance of the physical server PSV, but does not have a fixed value. For example, in a case where the processing performance of the known physical server PSV is relatively degraded by developing a new physical server PSV and the like, the coefficient COEF of the known physical server PSV may be reduced. The coefficient COEF is set to have a value increasing as the processing performance becomes higher.

The coefficient COEF is changed in accordance with the relative processing performance of the physical server PSV. Thus, the manager and the like of the information processing system 100A sets the coefficient COEF in the table PSV-SPC via the terminal device 38. That is, the coefficient COEF in the table PSV-SPC is held to have the maximum value which may be set, until the correct coefficient COEF is received from the terminal device 38 operated by the manager of the management server 20A. Since the coefficient COEF in the table PSV-SPC is set to have the maximum value (=“1”) by the physical management unit 22A, it is possible to calculate a provisional license number by using the default value of the coefficient COEF even in a case where the manager and the like forget setting of the coefficient COEF.

At this time, the coefficient COEF is set to have the maximum value for calculating a license number stricter than the actual license number. Thus, it is possible to suppress the occurrence of violating a license, by managing the license based on the license number calculated by using the coefficient COEF. On the contrary, for example, in a case where the license number is calculated by the default value which is smaller than the true coefficient COEF, the calculated license number may be smaller than a license number desired in practice, and the license may be violated.

The process of Step S108 may be performed between Steps S102 and S104 or between Steps S104 and S106. In addition, it is assumed that the coefficient COEF is held in the physical server PSV so as to be readable, and the table PSV-SPC is updated every time the coefficient COEF is changed. In this case, since the correct coefficient COEF read from the physical server PSV may be set in the table PSV-SPC, the process of Step S108 of setting the default value (maximum value) in the table PSV-SPC will be omitted.

Then, in Step S110, the physical management unit 22A determines whether or not a physical server PSV which is not selected in Step S102 is present among physical servers PSV as management targets. In a case where the physical server PSV which is not selected is present, the process returns to Step S102. In a case where all physical servers PSV have been selected, the process ends. After the processing illustrated in FIG. 8 has been completed, the true coefficient COEF output from the terminal device 38 operated by the manager is stored in the table PSV-SPC. Thus, in a case where the information processing system 100A includes the physical servers PSVa and PSVb illustrated in FIG. 4, the table PSV-SPC comes into the state illustrated in FIG. 6.

FIG. 9 illustrates an example of the operation of the image management unit 29A illustrated in FIG. 3. That is, FIG. 9 illustrates an example of the information processing method by the management server 20A and the program executed by the management server 20A. The operation illustrated in FIG. 9 is started based on that a virtual machine VM has been created in any physical server PSV by using a VM image based on an instruction from the user via the terminal device 40.

Firstly, in Step S200, the image management unit 29A stores information indicating a relation between the virtual machine VM created by using the VM image and a physical server PSV in which the virtual machine has been created, in the table PSV-VM. The process of Step S200 may be performed after Steps S202, S204, and S206, before Step S212, after Step S212, or after Step S214.

Then, in Step S202, the image management unit 29A stores a virtual machine name VM-NAM for identifying the virtual machine VM created by using the VM image and a software name SW-NAM of software included in the virtual machine VM, in the table SW-LCS. That is, the image management unit 29A stores software information corresponding to the VM image, in the table SW-LCS.

In Step S204, the image management unit 29A acquires the purchase unit LCS-UNIT and the license type LCS-TYPE of a license corresponding to the software included in the VM image used for creating the virtual machine VM, from the table IMG-LCS. Then, in Step S206, the image management unit 29A stores the purchase unit LCS-UNIT and the license type LCS-TYPE of the license, which have been acquired in Step S204, in the corresponding record in the table SW-LCS.

In Step S208, the image management unit 29A determines whether or not the license type LCS-TYPE acquired in Step S204 is “processor”. In a case where the license type LCS-TYPE is “processor”, the process proceeds to Step S210. In a case where the license type LCS-TYPE is not “processor”, that is, in a case where the license type LCS-TYPE is “server”, the process proceeds to Step S212. In Step S210, the image management unit 29A acquires specification information (number CORE-N of cores and coefficient COEF) of the physical server PSV in which the virtual machine VM has been created, from the table PSV-SPC. Then, the process proceeds to Step S212.

In Step S212, the image management unit 29A calculates the license number LCS-N of the software included in the VM image used for creating the virtual machine VM, and stores the calculated license number LCS-N in the corresponding record in the table SW-LCS. As illustrated in FIG. 5, in a case where the purchase unit LCS-UNIT of a license, and the license type LCS-TYPE of the license is “processor”, the license number LCS-N is calculated by using the number CORE-N of cores and the coefficient COEF which have been acquired in Step S210. In a case where the purchase unit LCS-UNIT of a license is “virtual”, and the license type LCS-TYPE of the license is “processor”, the license number LCS-N is calculated by the number vCPU-N of cores and the coefficient COEF acquired in Step S210. In a case where the purchase unit LCS-UNIT of the license is “server”, the license number LCS-N is set to “1”.

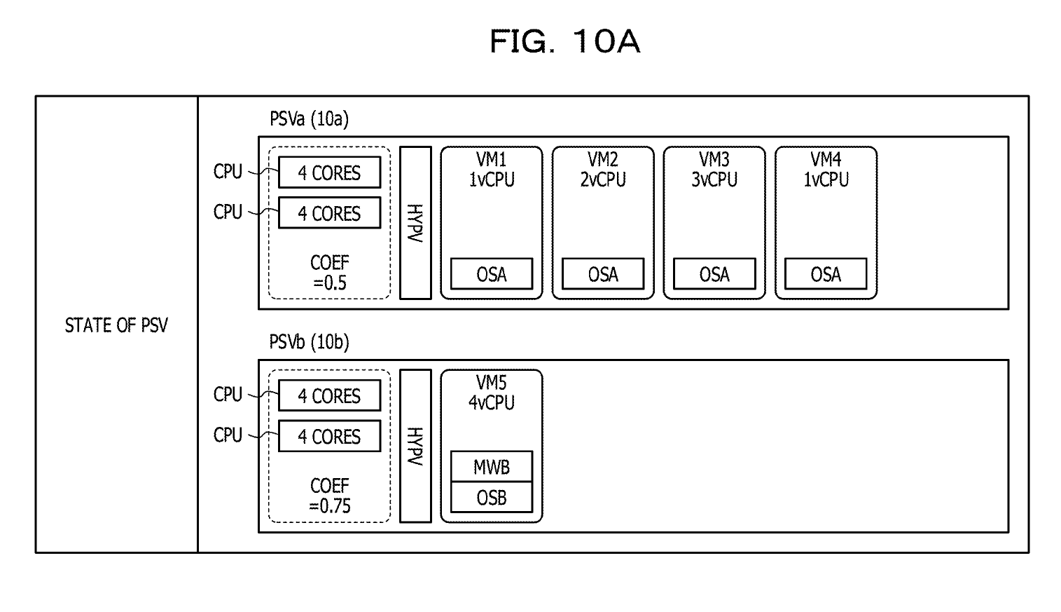

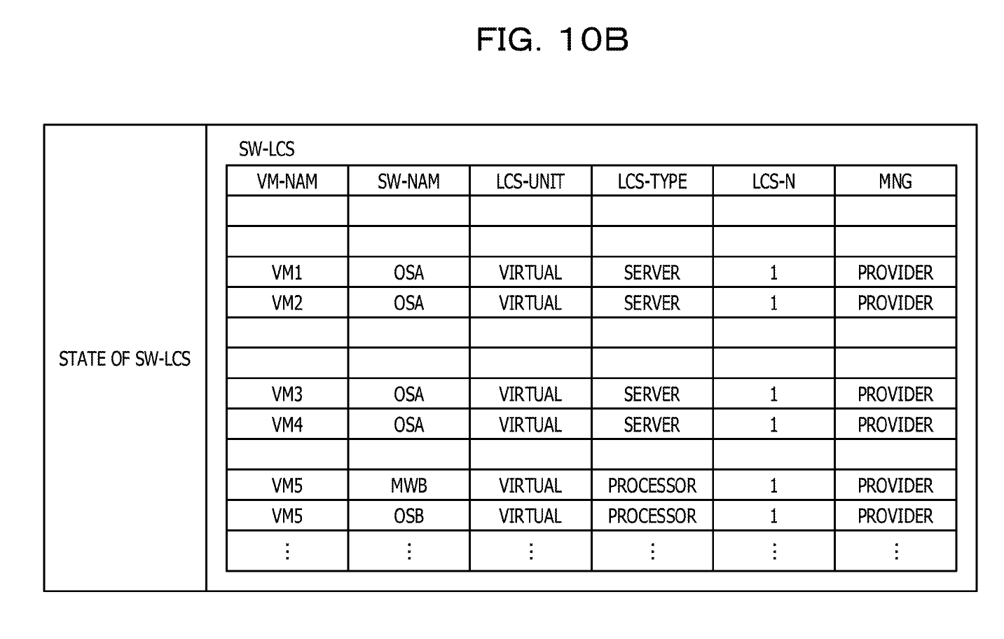

In Step S214, the image management unit 29A stores information indicating “provider” in the region of the corresponding management subject MNG, in the table SW-LCS. Then, the process ends. The process of Step S214 may be performed before Step S200, S202, S204, S206, and S208 or before Step S212. With the operation of the image management unit 29A illustrated in FIG. 9, every time the virtual machine VM is created in the physical server PSV by using the VM image, license information is stored in an empty record in the table SW-LCS, and the state illustrated in FIG. 10 occurs.

Since the region of the management subject MNG is provided in the table SW-LCS, it is possible to manage license information received from the user and license information of software included in the VM image prepared by the provider, by using the common table SW-LCS. Thus, as illustrated in FIG. 14, even in a case where the virtual machine VM moves between physical servers PSV, it is possible to determine whether or not moving the virtual machine VM is possible without depending on the management subject of the software, by using the common table SW-LCS.

FIG. 10 (i.e. FIGS. 10A and 10B) illustrates an example of the state of the information processing system 100A after the operation illustrated in FIG. 9 has been performed by the image management unit 29A. FIG. 10 illustrates the state before the user causes software to be installed on the virtual machines VM1, VM3, and VM5 in FIGS. 4 and 6. In the table group 34A, the states of the tables PSV-SPC, IMG-LCS, PSV-VM, and UUSE-LCS except for the table SW-LCS are identical to those in FIG. 6.

The image management unit 29A stores information indicating a relation between a physical server PSV and a virtual machine VM, in the table PSV-VM illustrated in FIG. 6 every time each of the virtual machines VM1 to VM5 is created in the physical server PSV. The image management unit 29A stores the virtual machine name VM-NAM and the software name SW-NAM in the table SW-LCS. The image management unit 29A reads information (LCS-UNIT, LCS-TYPE) regarding a license included in each of VM images IMGA and IMGB, from the table IMG-LCS illustrated in FIG. 6, and stores the information in the table SW-LCS.

The image management unit 29A calculates the license number LCS-N based in the information stored in the table SW-LCS and stores the calculated license number LCS-N in the table SW-LCS. Further, the image management unit 29A stores the information indicating “provider” as the management subject MNG, in the table SW-LCS.

The license information of software included in the virtual machine VM corresponding to the VM image is set by not the user but the image management unit 29A. That is, in the table SW-LCS illustrated in FIG. 10, a record in which the virtual machine VM corresponding to the VM image and the license information of software included in the virtual machine VM are held is a record in which the information indicating “provider” is stored in the region of the management subject MNG. Thus, it is possible to reduce a burden on the user in comparison to a case where the user is caused to input license information of all pieces of software included in the virtual machine VM.

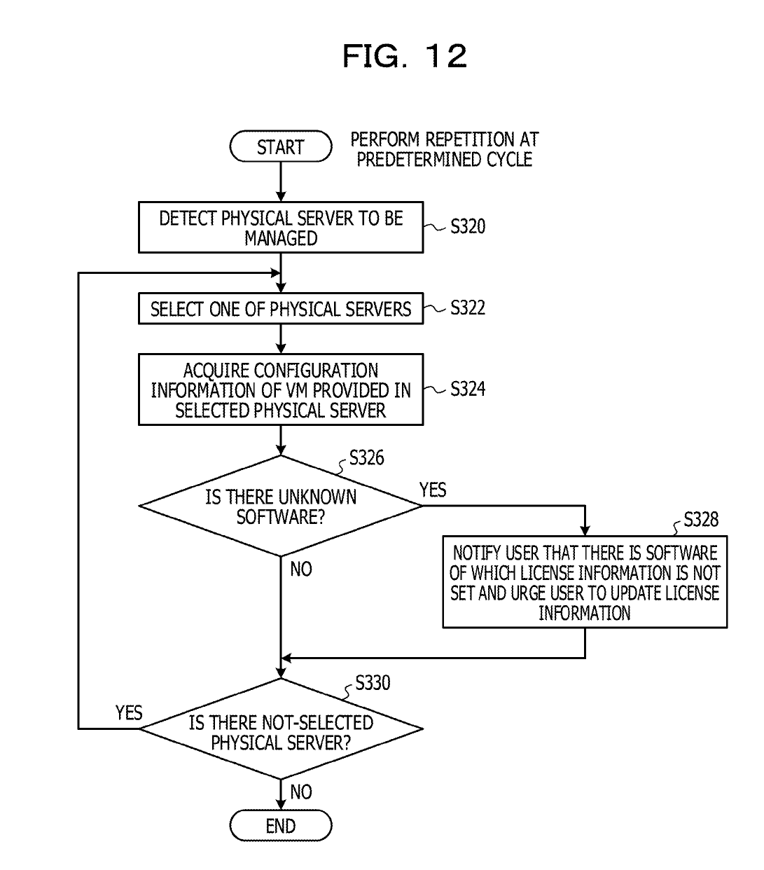

FIG. 11 illustrates an example of the operation of the user setting management unit 27A illustrated in FIG. 3. That is, FIG. 11 illustrates an example of the information processing method by the management server 20A and the program executed by the management server 20A. The operation flows illustrated in FIGS. 12 to 14 and FIGS. 17 to 22 also illustrate the information processing method by the management server 20A and the program executed by the management server 20A.

The operation illustrated in FIG. 11 is started based on that the user has logged into the cloud service realized by the information processing system 100A, with the terminal device 40. Firstly, in Step S300, the user setting management unit 27A determines whether or not a virtual machine VM including software of which license information has not been set in the table SW-LCS is provided among virtual machines VM held by the user. The virtual machine VM held by the user is represented by the virtual machine name VM-NAM included in a record in which information of identifying the user who has performed log-in is held in the region of the management subject MNG, in the table SW-LCS.

In a case where the virtual machine VM including software of which license information has not been set is provided in the table SW-LCS, the process proceeds to Step S302. In a case where license information of software installed on all virtual machines VM held by the user is set in the table SW-LCS, the process ends.

Here, in a case where the virtual machine VM created by the VM image includes only software included in the VM image, license information has been stored in the corresponding record in the table SW-LCS. Thus, the process ends. In a case where the virtual machine VM created by the VM image includes software which is other than the software included in the VM image and has license information which has not been set, the process proceeds to Step S302.

In Step S302, the user setting management unit 27A displays a list of the virtual machine VM of which license information has not been set in the table SW-LCS, on a screen of the terminal device 40 with which the user has performed log-in, based on the information held in the table SW-LCS. Then, in Step S304, the user setting management unit 27A causes the user to select any of virtual machines VM displayed on the screen of the terminal device 40, through the terminal device 40.

In Step S306, the user setting management unit 27A refers to the table PSV-SPC so as to output specification information of a physical server PSV including the virtual machine VM selected by the user to the terminal device 40 and to cause the specification information to be displayed on a screen of the terminal device 40. The specification information displayed on the screen includes the number CORE-N of cores and the coefficient COEF. The specification information displayed on the screen may include at least any of the thread number TH-N and the model class.

Then, in Step S308, the user setting management unit 27A displays a window on a screen of the terminal device 40. The window is used for causing the user to input the purchase unit LCS-UNIT, the license type LCS-TYPE, and the license number LCS-N of a license. In the window displayed on the screen of the terminal device 40, information (for example, software name SW-NAM) indicating software of which license information has not been input is provided.

The user setting management unit 27A performs processing of receiving the license information (purchase unit LCS-UNIT, license type LCS-TYPE, and license number LCS-N of license) input by the user with the terminal device 40. In a case where plural pieces of software have been installed on the virtual machine VM selected by the user, a window for inputting the purchase unit LCS-UNIT, the license type LCS-TYPE, and the license number LCS-N of the license for each piece of software may be displayed.

Then, in Step S310, the user setting management unit 27A stores the license information received in Step S308, in a record corresponding to the virtual machine VM held by the user in a log-in state, in the table SW-LCS. That is, the purchase unit LCS-UNIT, the license type LCS-TYPE, and the license number LCS-N of the license are stored in the record corresponding to software of which license information has not been set, in the table SW-LCS.

Then, the user setting management unit 27A manages the license information and the installation information (virtual machine name VM-NAM and software name SW-NAM) stored in the table SW-LCS. The installation information has been stored in the table SW-LCS based on that the software has been installed on the virtual machine VM. After Step S310, the process returns to Step S300. If the flow illustrated in FIG. 11 repeats, the state of the table SW-LCS sequentially changes from the state illustrated in FIG. 10 to the state illustrated in FIG. 6.

The user setting management unit 27A that outputs the specification information of a physical server PSV to the terminal device 40 and receives the license information from the terminal device 40 is an example of the interface unit. The user setting management unit 27A that manages software information indicating the correspondence between the license information received from the terminal device 40, software corresponding to the license information, and a virtual machine VM on which the software has been installed is an example of the virtual management unit.

In a case where the user logs out from the cloud service while the operation illustrated in FIG. 11 is being performed, the correct license information may not be set in the table SW-LCS. The operation illustrated in FIG. 12 is performed in order to suppress an occurrence of a situation in which a state where the correct license information is not set continues.

FIG. 12 illustrates another example of the operation of the user setting management unit 27A illustrated in FIG. 3. The operation illustrated in FIG. 12 is repeated at a predetermined cycle.

Firstly, in Step S320, the user setting management unit 27A refers to, for example, the table PSV-SPC illustrated in FIG. 6 so as to detect a physical server PSV to be managed by the management server 20A. In Step S322, the user setting management unit 27A selects one not-selected physical server PSV among detected physical servers PSV. In Step S324, the user setting management unit 27A refers to, for example, the tables PSV-VM and SW-LCS illustrated in FIG. 6 so as to acquire configuration information of a virtual machine VM included in the selected physical server PSV.

In Step S326, the user setting management unit 27A determines whether or not there is a virtual machine VM including unknown software of which license information is not set, based on the configuration information acquired in Step S324. For example, the unknown software is software corresponding to a record in which at least one of the purchase unit LCS-UNIT, the license type LCS-TYPE, and the license number LCS-N of a license is not held, in the table SW-LCS. In a case where the unknown software is included in the virtual machine VM, the process proceeds to Step S328. In a case where the unknown software is not included in the virtual machine VM, the process proceeds to Step S330.

In Step S328, the user setting management unit 27A acquires user information of identifying the user from the region of the management subject MNG in the record in which license information is not set, in the table SW-LCS. The user setting management unit 27A notifies each user that there is software of which license information has not been set, based on the acquired user information. The user setting management unit 27A urges each user to update the license information, and then causes the process to proceed to Step S330. For example, the user is notified by an electronic mail. For example, the user receiving the notification by an electronic mail logs into the cloud service realized by the information processing system 100A. Then, the user inputs the license information to the terminal device 40 in accordance with the processing flow which is performed by the user setting management unit 27A and is illustrated in FIG. 11. In a case where the user has logged into the cloud service, the user inputs the license information to the terminal device 40 in accordance with the processing flow illustrated in FIG. 11.

In Step S330, in a case where there is a physical server PSV which has not been selected in Step S322, the user setting management unit 27A causes the process to proceed to Step S322. In a case where all physical servers PSV have been selected, the user setting management unit 27A ends the process. The notification for the user may be collectively performed for each user, after all the physical servers PSV have been selected.

Since it is determined whether or not there is a virtual machine VM including unknown software of which license information has not been set, by referring to the table SW-LCS at a predetermined cycle, it is possible to detect omission of setting license information by the user and to urge the user to input the license information. Since the omission of setting the license information is suppressed, as illustrated in FIG. 14, it is possible to suppress an occurrence of a situation in which determination of whether or not moving the virtual machine VM is possible is erroneously performed, in a case where the virtual machine VM is moved between physical servers PSV.

FIG. 13 illustrates still another example of the operation of the user setting management unit 27A illustrated in FIG. 3. The operation illustrated in FIG. 13 is started in a case where an instruction to delete the virtual machine VM is received from the user via the terminal device 40, and the overall management unit 30A deletes the virtual machine VM as the instruction target.

Firstly, in Step S400, the user setting management unit 27A searches for the table PSV-VM, finds a record including the virtual machine name VM-NAM indicating the deleted virtual machine VM, and deletes information included in the found record. The user setting management unit 27A searches for the table SW-LCS, finds a record including the virtual machine name VM-NAM indicating the deleted virtual machine VM, and deletes information held in the found record. In a case where software has not been installed on the deleted virtual machine VM, the information regarding the deleted virtual machine VM is not held in the table SW-LCS.

Then, in Step S402, in a case where software has been installed on the deleted virtual machine VM, the user setting management unit 27A causes the process to proceed to Step S404 in order to manage the extra license number with following deletion of the virtual machine VM. In a case where the software has not been installed on the deleted virtual machine VM, the user setting management unit 27A ends the process because the management of the extra license number with following deletion of the virtual machine VM is not desired. For example, it may be determined whether or not software has been installed on the deleted virtual machine VM, based on whether or not the information of the record in the table SW-LCS has been deleted in Step S400.

In Step S404, the user setting management unit 27A determines whether or not another virtual machine VM including software as same as software included in the deleted virtual machine VM is provided in a physical server PSV in which the virtual machine VM has been deleted. In a case where another virtual machine VM including the same software is provided, the extra license number does not occur. Thus, the process ends. In a case where another virtual machine VM including the same software is not provided, the extra license number occurs. Thus, the process proceeds to Step S406.

In Step S406, the user setting management unit 27A stores the information deleted from the table SW-LCS, in the table UUSE-LCS, and then ends the process. For example, the user setting management unit 27A stores the software name SW-NAM, the purchase unit LCS-UNIT and the license type LCS-TYPE of the license, which have been deleted from the table SW-LCS, in an empty record in the table UUSE-LCS. The user setting management unit 27A stores the license number LCS-N deleted from the table SW-LCS, as the not-used license number UUSE-LCS-N, in a record corresponding to the software name SW-NAM in the table UUSE-LCS. That is, the user setting management unit 27A holds the information deleted from the table SW-LCS, as the not-used license information, in the table UUSE-LCS.

When the virtual machine VM is deleted, the license of the software included in the deleted virtual machine VM is held as the not-used license number (extra license). Thus, it is possible to use a not-used license, for example, in a case where a CPU or a vCPU is added. Thus, it is possible to suppress purchase of an extra license by the user. The user setting management unit 27A has a function of displaying the not-used license number held in the table UUSE-LCS, on a screen of the terminal device 40 based on a request from the user. Thus, for example, in a case where a vCPU is added in the virtual machine VM, the user may determine whether or not the additional purchase of a license for software installed on the virtual machine VM, based on the not-used license number.

FIG. 14 illustrates an example of the operation of the movement management unit 28A illustrated in FIG. 3. The operation illustrated in FIG. 14 is started based on an instruction from the overall management unit 30A, before the management server 20A moves the virtual machine VM between physical servers 10.

Firstly, in Step S500, the movement management unit 28A refers to the table SW-LCS so as to determine whether or not the purchase unit LCS-UNIT of a license of software included in a virtual machine VM as a movement target is “physical”. In a case where the purchase unit LCS-UNIT of the license is “physical”, the process proceeds to Step S502. In a case where the purchase unit LCS-UNIT of the license is not “physical”, that is, in a case of “virtual”, moving the virtual machine VM between physical servers PSV is not restricted. Thus, the process proceeds to Step S512. In a case where the virtual machine VM as the movement target includes plural pieces of software, and the purchase unit LCS-UNIT of at least one license of the software is “physical”, the process proceeds to Step S502.

In Step S502, the movement management unit 28A refers to the table SW-LCS so as to determine whether or not the license type LCS-TYPE of the software included in the virtual machine VM as the movement target is “processor”. In a case where the license type LCS-TYPE is “processor”, the process proceeds to Step S504. That is, in a case where the purchase unit LCS-UNIT of the license of the software is “physical”, and the license type LCS-TYPE of the software is “processor”, the process proceeds to Step S504.

In a case where the license type LCS-TYPE is not “processor”, that is, in a case of “server”, moving the virtual machine VM between physical servers PSV is not restricted. Thus, the process proceeds to Step S512. In a case where the virtual machine VM as the movement target includes plural pieces of software, and the license type LCS-TYPE of at least one license of the software is “processor”, the process proceeds to Step S504. The processes of Steps S504, S506, and S508 are performed for each piece of software in which the license type LCS-TYPE is “processor”. In a case where determination that “moving is not possible” is received for at least one of the plural pieces of software, the process proceeds to Step S510.

In Step S504, the movement management unit 28A determines whether or not a virtual machine VM including software as same as software included in the virtual machine VM as the movement target is created in a physical server PSV as a movement destination of the virtual machine VM. In a case where the purchase unit LCS-UNIT of a license of the software is “physical”, the license of the software may be shared between a plurality of virtual machines, in a unit of a physical server PSV. Therefore, in a case where the physical server PSV as the movement destination includes the virtual machine VM including the same software, the software included in the virtual machine VM as the movement target may be operated by using the license of the software included in the virtual machine VM of the physical server PSV as the movement destination. Since the moving the virtual machine VM is possible, the process proceeds to Step S512. In a case where the virtual machine VM including software having the same license is not created in the physical server PSV as the movement destination, the process proceeds to Step S506 in order to search a possibility of moving.

In the physical server PSV, in a case where a plurality of virtual machines VM includes the same software, the software is integrally managed by the common license. In other words, the same license is assigned to the same software. Therefore, the movement management unit 28A does not refer to the purchase unit LCS-UNIT and the license type LCS-TYPE of a license, but to the software name SW-NAM, and thus may determine a virtual machine including software having the same license.

In Step S506, the movement management unit 28A determines whether or not another virtual machine VM including software as same as software included in the virtual machine VM as the movement target is created in the physical server PSV as a movement source. As described above, the same license is assigned to the same software. Therefore, in a case where any of a plurality of virtual machines VM including the same software is moved to another physical server PSV including a virtual machine VM which does not include the same software, the license is violated. In a case where the license is violated, the process proceeds to Step S510. In a case where another virtual machine VM including software as same as software included in the virtual machine VM as the movement target is not provided in the physical server PSV as the movement source, the process proceeds to Step S508.

In Step S508, the movement management unit 28A determines whether or not the license number LCS-N desired for software in the physical server PSV as the movement source is equal to or greater than the license number LCS-N desired for software in the physical server PSV as the movement destination. Here, the license number LCS-N desired for the software is calculated by a product of the number CORE-N of cores in the physical server PSV and the coefficient COEF.

In a case where the license number LCS-N in the movement source is equal to or greater than the license number LCS-N in the movement destination, the license number LCS-N before the virtual machine VM is moved is sufficient as the desired license number LCS-N of software after the virtual machine VM has been moved. Therefore, it is determined that moving the virtual machine VM is possible. The process proceeds to Step S512. In a case where the license number LCS-N in the movement source is smaller than the license number LCS-N in the movement destination, the license number LCS-N before the virtual machine VM is moved is not sufficient as the desired license number LCS-N of software after the virtual machine VM has been moved. Therefore, it is determined that moving the virtual machine VM is not possible, and the process proceeds to Step S510.

In Step S510, the movement management unit 28A notifies the overall management unit 30A of not-possibility information indicating that moving the virtual machine VM is not possible, and ends the process. In Step S512, the movement management unit 28A notifies the overall management unit 30A of possibility information indicating that moving the virtual machine VM is possible, and ends the process.

The overall management unit 30A receiving the possibility information moves the virtual machine VM between the physical servers PSV. The overall management unit 30A changes a physical server name PSV-NAM in a record holding a virtual machine name VM-NAM of the moved virtual machine VM, in the table PSV-VM, to information indicating the physical server PSV as the movement destination. As described above, it is possible to determine whether or not moving the virtual machine VM is possible, by referring to the license information managed by the table SW-LCS, even in a case where the license number desired for license number depends on the performance of the physical server PSV in which the virtual machine VM is set. For example, it is possible to determine whether or not moving the virtual machine VM between physical servers PSV provided in a private cloud or a public cloud is possible. It is assumed that each of the private cloud and the public cloud manages the license information by using the table SW-LCS. In this case, it is possible to determine whether or not moving the virtual machine VM between the private cloud and the public cloud is possible.

In a case where the license number LCS-N in the movement source is greater than the license number LCS-N in the movement destination, the license number LCS-N becomes surplus by moving the virtual machine VM to the physical server PSV as the movement destination. In this case, the overall management unit 30A which has received the notification that moving is possible and has moved the virtual machine VM secures the license number LCS-N which becomes surplus by moving the virtual machine VM, in the table UUSE-LCS, as the not-used license number UUSE-LCS-N.

The virtual machine VM having determination that moving is not possible may be moved by using the not-used license number UUSE-LCS-N held in the table UUSE-LCS. For example, in a case where determination to be “Yes” is performed in Step S506, or in a case where determination to be “No” is performed in Step S508, the not-used license number UUSE-LCS-N may be used. In a case where the not-used license number UUSE-LCS-N is greater than the desired license number LCS-N of the software after the virtual machine VM has been moved, the virtual machine VM may be moved by using the not-used license number UUSE-LCS-N.

In a case using the not-used license number UUSE-LCS-N, the overall management unit 30A updates the not-used license number UUSE-LCS-N held in the table UUSE-LCS, based on that the virtual machine VM has been moved. Thus, it is possible to suppress an occurrence of a situation in which a wasteful license is purchased by the user in a case where the virtual machine VM is moved to another physical server PSV, and thereby the license for software included in the virtual machine VM is violated.

The not-used license number UUSE-LCS-N is also used when a CPU is added, or a vCPU is added. The not-used license number UUSE-LCS-N in the table UUSE-LCS decreases in a case where a CPU or a vCPU has been added, and increases in a case where a CPU or a vCPU has been removed.

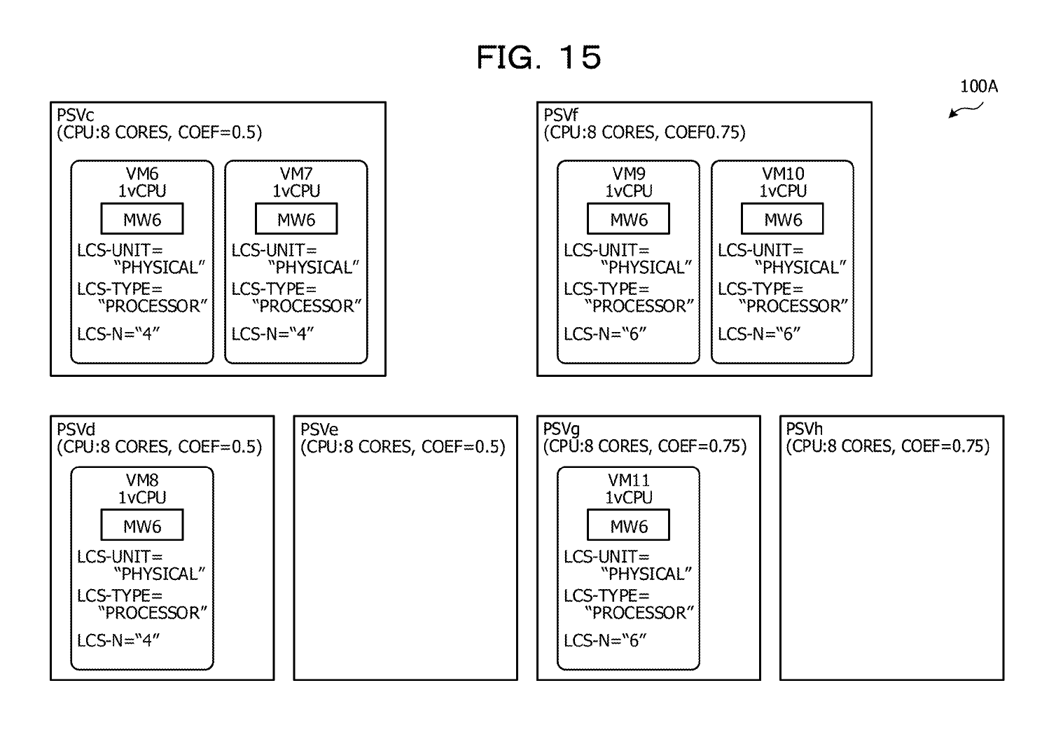

FIG. 15 illustrates another example of the virtual machine VM set in the physical server PSV illustrated in FIG. 3. Regarding the same or similar components as or to those in FIG. 4, detailed descriptions will not be repeated. In FIG. 15, the information processing system 100A includes physical servers PSVc, PSVd, PSVe, PSVf, PSVg, and PSVh. Specifications (number of cores=“8”, coefficient COEF=“0.5”) of the physical servers PSVc, PSVd, and PSVe are identical to each other. Specifications (number of cores =“8”, coefficient COEF=“0.75”) of the physical servers PSVf, PSVg, and PSVh are identical to each other.

The physical server PSVc includes virtual machines VM6 and VM7. The physical server PSVd includes a virtual machine VM8. The physical server PSVe does not include a virtual machine VM. The physical server PSVf includes virtual machines VM9 and VM10. The physical server PSVg includes a virtual machine VM11. The physical server PSVh does not include a virtual machine VM.

Each of the virtual machines VM6 to VM11 includes software MW6 in which the purchase unit LCS-UNIT of the license is “physical”, and the license type LCS-TYPE thereof is “processor”. One vCPU is assigned to each of the virtual machines VM6 to VM11. The license number LCS-N desired for software included in each of the virtual machines VM6 to VM8 is “4”. The license number LCS-N desired for software included in each of the virtual machines VM9 to VM11 is “6”.

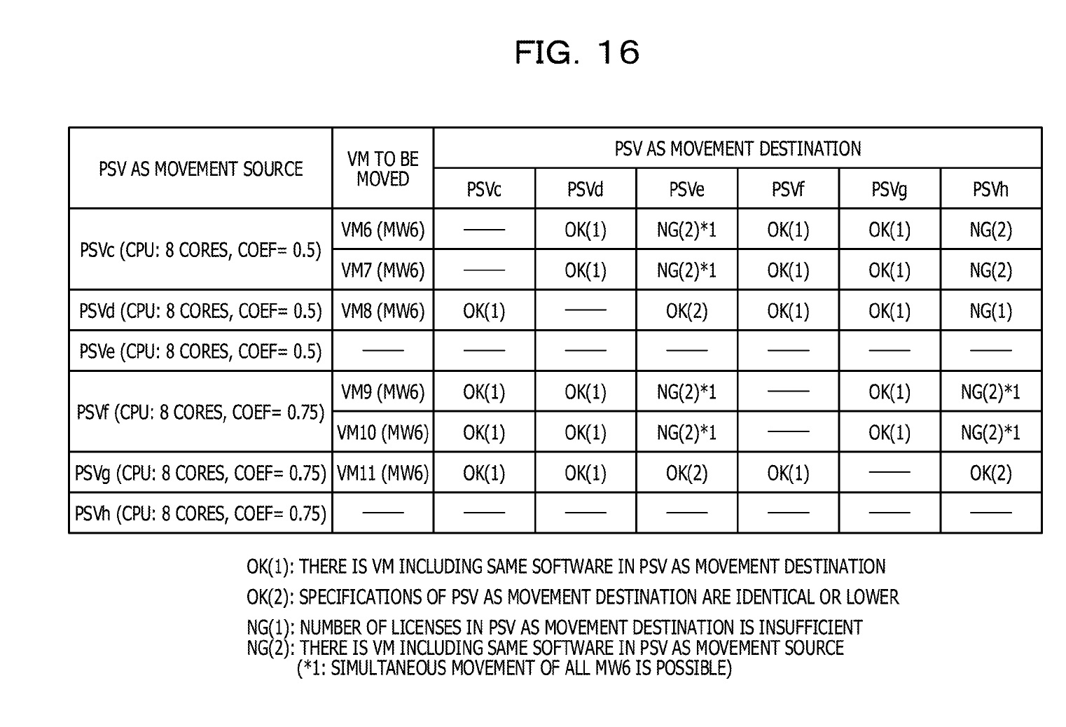

FIG. 16 illustrates an example for whether or not moving the virtual machine VM illustrated in FIG. 15 is possible.

Each of the virtual machines VM6 and VM7 including software MW6 in the physical server PSVc may be moved to the physical servers PSVd, PSVf, and PSVg including the same software MW6 (OK(1)). It is not possible that each of the virtual machines VM6 and VM7 including the software MW6 is moved to the physical servers PSVe and PSVh which do not include the same software MW6 (NG(2)). This is because the license of the software MW6 included in the virtual machines VM6 and VM7 is not integrally maintained. However, moving both the virtual machines VM6 and VM7 including all pieces of software MW6 in the physical server PSVc to the physical server PSVe is possible because the license is integrally maintained (NG(2)*1). Meanwhile, moving both the virtual machines VM6 and VM7 including all pieces of software MW6 in the physical server PSVc to the physical server PSVh is not possible because the desired license number LCS-N does not satisfy “2”.

The virtual machine VM8 including the software MW6 in the physical server PSVd may be moved to the physical servers PSVc, PSVf, and PSVg including the same software MW6 (OK(1)). The virtual machine VM8 including the software MW6 may be moved to the physical server PSVe having specifications which are identical to those of the physical server PSVd (OK(2)). Moving the virtual machine VM8 including the software MW6 to the physical server PSVh is not possible because the desired license number LCS-N does not satisfy “2” (NG(1)).

Each of the virtual machines VM9 and VM10 including software MW6 in the physical server PSVf may be moved to the physical servers PSVc, PSVd, and PSVg including the same software MW6 (OK(1)). It is not possible that each of the virtual machines VM9 and VM10 including the software MW6 is moved to the physical servers PSVe and PSVh which do not include the same software MW6 (NG(2)). However, moving both the virtual machines VM9 and VM10 including all pieces of software MW6 in the physical server PSVf to the physical server PSVe or the physical server PSVh is possible because the license is integrally maintained (NG(2)*1).

The virtual machine VM11 including the software MW6 in the physical server PSVg may be moved to the physical servers PSVc, PSVd, and PSVf including the same software MW6 (OK(1)). The virtual machine VM11 including the software MW6 may be moved to the physical servers PSVe and PSVh having specifications which are identical to or lower than those of the physical server PSVg (OK(2)).

FIG. 17 illustrates an example of an operation of the overall management unit 30A illustrated in FIG. 3 when a CPU in a physical server PSV is added. In a case where a CPU in a physical server PSV is added, a virtual machine VM included in the physical server PSV in which the CPU is added is moved to another physical server PSV by a method such as live migration, during a period until adding the CPU is completed, for example. The operation illustrated in FIG. 17 is started based on that an instruction to determine whether or not adding a CPU is possible has been received from the manager via the terminal device 38.

Firstly, in Step S600, the overall management unit 30A determines whether or not a virtual machine VM is provided in a physical server PSV as a target of adding a CPU. In a case where the virtual machine VM is provided in the target physical server PSV, the process proceeds to Step S610 in order to determine whether or not adding a CPU is possible. In a case where the virtual machine VM is not provided in the target physical server PSV, the process proceeds to Step S650 because adding a CPU is possible.

In Step S610, the overall management unit 30A determines whether or not adding a CPU in the target physical server PSV is possible. FIG. 18 illustrates an example of the process of Step S610. Then, in Step S640, the overall management unit 30A causes the process to proceed to Step S650 in a case where it is determined that adding a CPU in the target physical server PSV is possible, and causes the process to proceed to Step S680 in a case where adding a CPU in the target physical server PSV is not possible.

In Step S650, the overall management unit 30A notifies the manager of information indicating that adding a CPU is possible, by outputting the information to the terminal device 38. The manager receiving the notification causes a CPU in the target physical server PSV to be added. Then, in Step S660, the overall management unit 30A acquires specification information regarding specifications of the target physical server PSV, from the target physical server PSV and determines whether or not the CPU has been added. The overall management unit 30A repeats Step S660 until determining that the CPU has been added. In a case where it is determined that the CPU has been added, the overall management unit 30A causes the process to proceed to Step S670. The overall management unit 30A may cause the process to proceed to Step S670, based on detection that the target physical server PSV restarts after the CPU has been added. The overall management unit 30A may end the process after Step S650, and may start Step S670 instead of Step S660, based on, for example, an interrupt request indicating that the CPU has been added.

In Step S670, the overall management unit 30A determines whether or not the virtual machine VM has been moved from the physical server PSV in which the CPU is added to another physical server PSV, before the CPU is added. That is, the overall management unit 30A performs the process of Step S622 illustrated in FIG. 18 so as to determine whether or not the virtual machine VM has been moved to another physical server PSV. In a case where the virtual machine VM has been moved, the process proceeds to Step S672. In a case where the virtual machine VM is not moved, the process proceeds to Step S674. In Step S672, the overall management unit 30A brings the virtual machine VM moved to another physical server back to the physical server PSV in which the CPU has been added, by live migration or the like. Then, the overall management unit 30A causes the process to proceed to Step S674.

In Step S674, the overall management unit 30A causes the process to proceed to Step S676 in a case using the not-used license number UUSE-LCS-N with adding the CPU, and ends the process in a case where the not-used license number UUSE-LCS-N is not used. In Step S676, the overall management unit 30A subtracts the license number to be used from the not-used license number UUSE-LCS-N held in the table UUSE-LCS, and then ends the process. The overall management unit 30A may subtract the license number to be used from the not-used license number UUSE-LCS-N held in a plurality of records in the table UUSE-LCS. In a case where the CPU is added, it is possible to suppress purchase of a wasteful license by the user, by using the not-used license number UUSE-LCS-N. In Step S690, the overall management unit 30A notifies the manager of information indicating that adding the CPU is not possible, by outputting the information to the terminal device 38. Then, the overall management unit 30A ends the process.

FIG. 18 illustrates an example of the process of Step S610 in FIG. 17. Firstly, in Step S612, the overall management unit 30A selects a virtual machine VM included in the target physical server PSV in which the CPU is added, as a virtual machine VM as a determination target. In Step S614, the overall management unit 30A causes the movement management unit 28A to determine whether or not moving the virtual machine VM as the determination target to another physical server PSV is possible. The movement management unit 28A performs the operation illustrated in FIG. 14 and determines whether or not moving the virtual machine VM as the determination target to another physical server PSV is possible.

In Step S616, the overall management unit 30A causes the process to proceed to Step S618 in a case where the movement management unit 28A determines that moving the virtual machine VM is possible. In a case where the movement management unit 28A determines that moving the virtual machine VM is not possible, it is difficult to move the virtual machine VM to another physical server PSV in order to add a CPU. Thus, the overall management unit 30A causes the process to proceed to Step S626.

In Step S618, the overall management unit 30A refers to the table UUSE-LCS so as to determine whether or not the not-used license number UUSE-LCS-N is provided. In a case where the not-used license number UUSE-LCS-N is provided, the overall management unit 30A causes the process to proceed to Step S620. In a case where the not-used license number UUSE-LCS-N is not provided, it is not possible to avoid license violation of software, which occurs in a case where the virtual machine VM has been brought back to the physical server PSV in which a CPU has been added. Thus, the overall management unit 30A causes the process to proceed to Step S626.

In Step S620, the overall management unit 30A determines whether or not the not-used license number UUSE-LCS-N is usable, in order to avoid the occurrence of license violation of software by adding a CPU. That is, the overall management unit 30A determines whether or not to supplement the license number LCS-N increasing in a case where a CPU has been added, by using the not-used license number UUSE-LCS-N. In a case where the increasing license number LCS-N is supplemented by using the not-used license number UUSE-LCS-N, adding a CPU is possible. Thus, the process proceeds to Step S622. In a case where the increasing license number LCS-N is not supplemented by using the not-used license number UUSE-LCS-N, adding a CPU is not possible. Thus, the process proceeds to Step S626.

In Step S622, the overall management unit 30A moves the virtual machine VM included in the physical server PSV in which a CPU is added, to another physical server PSV by live migration or the like. Then, the overall management unit 30A causes the process to proceed to Step S624.

In Step S624, the overall management unit 30A determines that adding a CPU is possible, ends the process of Step S610 illustrated in FIG. 18, and causes the process to proceed to Step S640 in FIG. 17. In Step S626, the overall management unit 30A determines that adding a CPU is not possible, ends the process of Step S610, and causes the process to proceed to Step S640 in FIG. 17.

With the process in FIG. 18, it is possible to determine whether or not adding a CPU is possible, even in a case where the virtual machine VM set in the physical server PSV in which a CPU is added includes software having a license number which changes depending on the physical server 10. That is, it is possible to determine whether or not license of software included in the virtual machine VM to be moved is violated in a case where the virtual machine VM is moved to another physical server PSV in order to add a CPU. In addition, it is possible to determine whether or not license violation occurs in the software included in the virtual machine VM brought back to the physical server PSV after a CPU has been added, by addition of the CPU. As a result, it is possible to add a CPU in the physical server PSV without violating the license of software installed by the user.

FIG. 19 illustrates an example of an operation of the overall management unit 30A illustrated in FIG. 3 when the CPU in a physical server PSV is removed. In a case where a CPU in a physical server PSV is removed, a virtual machine VM included in the physical server PSV in which the CPU is removed is moved to another physical server PSV by a method such as live migration, during a period until removing the CPU is completed, for example. The operation illustrated in FIG. 19 is started based on that an instruction to determine whether or not removing a CPU is possible has been received from the manager via the terminal device 38.

Firstly, in Step S700, the overall management unit 30A determines whether or not a virtual machine VM is provided in a physical server PSV as a target of removing a CPU. In a case where the virtual machine VM is provided in the target physical server PSV, the process proceeds to Step S710 in order to determine whether or not removing a CPU is possible. In a case where the virtual machine VM is not provided in the target physical server PSV, the process proceeds to Step S750 because removing a CPU is possible.

In Step S710, the overall management unit 30A determines whether or not removing the CPU in the target physical server PSV is possible. FIG. 20 illustrates an example of the process of Step S710. Then, in Step S740, the overall management unit 30A causes the process to proceed to Step S750 in a case where it is determined that removing a CPU in the target physical server PSV is possible, and causes the process to proceed to Step S780 in a case where removing a CPU in the target physical server PSV is not possible.

In Step S750, the overall management unit 30A notifies the manager of information indicating that removing a CPU is possible, by outputting the information to the terminal device 38. The manager receiving the notification causes a CPU in the target physical server PSV to be removed. Then, in Step S760, the overall management unit 30A acquires specification information regarding specifications of the target physical server PSV, from the target physical server PSV and determines whether or not the CPU has been removed. The overall management unit 30A repeats Step S760 until determining that the CPU has been removed. In a case where it is determined that the CPU has been removed, the overall management unit 30A causes the process to proceed to Step S770. The overall management unit 30A may cause the process to proceed to Step S770, based on detection that the target physical server PSV restarts after the CPU has been removed. The overall management unit 30A may end the process after Step S750, and may start Step S770 instead of Step S760, based on, for example, an interrupt request indicating that the CPU has been removed.

In Step S770, the overall management unit 30A determines whether or not the virtual machine VM has been moved from the physical server PSV in which the CPU has been removed to another physical server PSV. That is, the overall management unit 30A performs the process of Step S720 illustrated in FIG. 20 so as to determine whether or not the virtual machine VM has been moved to another physical server PSV. In a case where the virtual machine VM has been moved, the process proceeds to Step S772. In a case where the virtual machine VM is not moved, the process proceeds to Step S774. In Step S772, the overall management unit 30A brings the virtual machine VM moved to another physical server back to the physical server PSV in which the CPU has been removed, by live migration or the like. Then, the overall management unit 30A causes the process to proceed to Step S774.

In Step S774, the overall management unit 30A causes the process to proceed to Step S776 in a case where the not-used license number UUSE-LCS-N is generated with removing the CPU, and ends the process in a case where the not-used license number UUSE-LCS-N is not generated. In Step S776, the overall management unit 30A adds the generated not-used license number UUSE-LCS-N in the table UUSE-LCS, and then ends the process. It is possible to reduce a probability of violating a license in a case where the virtual machine VM is moved to another physical server PSV after a CPU is removed, by holding the license number which becomes surplus by removing the CPU, as the not-used license number UUSE-LCS-N. That is, it is possible to effectively use the license purchased by the user without making the license wasteful. In Step S780, the overall management unit 30A notifies the manager of information indicating that removing the CPU is not possible, by outputting the information to the terminal device 38. Then, the overall management unit 30A ends the process.

FIG. 20 illustrates an example of the process of Step S710 illustrated in FIG. 19. Regarding the same or similar processes as or to that in those in FIG. 18, detailed descriptions will not be repeated. Firstly, in Step S712, the overall management unit 30A selects a virtual machine VM included in the target physical server PSV in which the CPU is removed, as a virtual machine VM as a determination target. In Step S714, the overall management unit 30A causes the movement management unit 28A to determine whether or not moving the virtual machine VM as the determination target to another physical server PSV is possible. The movement management unit 28A performs the operation illustrated in FIG. 14 and determines whether or not moving the virtual machine VM as the determination target to another physical server PSV is possible.

In Step S716, the overall management unit 30A causes the process to proceed to Step S720 in a case where all virtual machines VM including software having a license depending on the specifications of the physical server PSV may be moved to another physical server PSV. In a case where it is not possible to move the virtual machine VM to another physical server PSV, the overall management unit 30A causes the process to proceed to Step S724.

In Step S720, the overall management unit 30A moves the virtual machine VM included in the physical server PSV in which a CPU is removed, to another physical server PSV by live migration or the like. Then, the overall management unit 30A causes the process to proceed to Step S722. In Step S722, the overall management unit 30A determines that removing a CPU is possible, ends the process of Step S710 illustrated in FIG. 20, and causes the process to proceed to Step S740 in FIG. 19. In Step S724, the overall management unit 30A determines that removing a CPU is not possible, ends the process of Step S710, and causes the process to proceed to Step S740 in FIG. 19.

With the process in FIG. 20, it is possible to determine whether or not removing a CPU is possible, even in a case where the virtual machine VM set in the physical server PSV in which a CPU is removed includes software having a license number which changes depending on the physical server 10. That is, it is possible to determine whether or not license of software included in the virtual machine VM to be moved is violated in a case where the virtual machine VM is moved to another physical server PSV in order to remove a CPU. As a result, it is possible to remove a CPU in the physical server PSV without violating the license of software installed by the user.

FIG. 21 illustrates an example of an operation of the overall management unit 30A illustrated in FIG. 3 when a vCPU of a virtual machine VM is added. The operation illustrated in FIG. 21 is started based on that an inquiry of whether or not adding a vCPU is possible has been received from the terminal device 40 operated by the user.

Firstly, in Step S800, the overall management unit 30A refers to the table SW-LCS so as to acquire license information of software included in a virtual machine VM as a target of determining whether or not adding a vCPU is possible. Then, in Step S802, the overall management unit 30A determines whether or not the purchase unit LCS-UNIT of a license of software included in the virtual machine VM as a determination target is “virtual”, and the license type LCS-TYPE thereof is “processor”. In a case where the purchase unit LCS-UNIT of a license is “virtual”, and the license type LCS-TYPE thereof is “processor”, the process proceeds to Step S804. In a case where the purchase unit LCS-UNIT of a license is “physical”, or the license type LCS-TYPE thereof is “server”, the process proceeds to Step S808.

In Step S804, the overall management unit 30A refers to the table UUSE-LCS. In a case where the not-used license number UUSE-LCS-N is provided, the overall management unit 30A causes the process to proceed to Step S806. In a case where the not-used license number UUSE-LCS-N is not provided in the table UUSE-LCS, the overall management unit 30A causes the process to proceed to Step S814.

In Step S806, the overall management unit 30A determines whether or not the not-used license number UUSE-LCS-N is usable, in order to add a vCPU. That is, the overall management unit 30A determines whether or not to supplement the license number LCS-N increasing in a case where a vCPU has been added, by using the not-used license number UUSE-LCS-N. In a case where the increasing license number LCS-N is supplemented by using the not-used license number UUSE-LCS-N, the process proceeds to Step S808. In a case where the increasing license number LCS-N is not supplemented by using the not-used license number UUSE-LCS-N, the process proceeds to Step S814.

In Step S808, the overall management unit 30A notifies the user of information indicating that adding a vCPU is possible, by outputting the information to the terminal device 40. For example, the user receiving the notification causes a vCPU of the virtual machine VM as the determination target to be added. Then, in Step S810, the overall management unit 30A determines whether or not a vCPU has been added by the user, based on information held in the physical server PSV including the virtual machine VM as the determination target. The overall management unit 30A repeats Step S810 until determining that the vCPU has been added. In a case where the overall management unit 30A determines that the vCPU has been added, the overall management unit 30A causes the process to proceed to Step S812. The overall management unit 30A may end the process after Step S808, and may start Step S812 instead of Step S810, based on, for example, an interrupt request indicating that the vCPU has been added.

In Step S812, the overall management unit 30A subtracts the license number to be used for adding a vCPU from the not-used license number UUSE-LCS-N held in the table UUSE-LCS, and then ends the process. In Step S814, the overall management unit 30A notifies the user of information indicating that adding the CPU is not possible, by outputting the information to the terminal device 40. Then, the overall management unit 30A ends the process.

FIG. 22 illustrates an example of an operation of the overall management unit 30A illustrated in FIG. 3 when a vCPU of a virtual machine VM is removed. The operation illustrated in FIG. 22 is started based on that a vCPU in a predetermined virtual machine VM has been removed by the user.

Firstly, in Step S900, the overall management unit 30A refers to the table SW-LCS so as to acquire license information of software included in a virtual machine VM in which a vCPU has been removed. Then, in Step S902, the overall management unit 30A determines whether or not the purchase unit LCS-UNIT of a license of software included in the virtual machine VM in which a vCPU has been removed is “virtual”, and the license type LCS-TYPE thereof is “processor”. In a case where the purchase unit LCS-UNIT of a license is “virtual”, and the license type LCS-TYPE thereof is “processor”, the process proceeds to Step S904. In a case where the purchase unit LCS-UNIT of a license is “physical”, or the license type LCS-TYPE thereof is “server”, the process ends. In Step S904, the overall management unit 30A adds the not-used license number UUSE-LCS-N generated with removing the vCPU to the table UUSE-LCS, and ends the process.

As described above, even in the embodiment illustrated in FIGS. 3 to 22, it is possible to obtain effects similar to those in the embodiment illustrated in FIGS. 1 and 2. For example, it is possible to manage software information which is information regarding software installed by the user and includes the license number which changes depending on the physical server 10 in which the software is installed. Thus, it is possible to determine whether or not moving a virtual machine VM on which software has been installed by the user, between physical servers PSV is possible. Further, in the embodiment illustrated in FIGS. 3 to 22, it is possible to obtain effects as follows.

It is possible to determine whether or not license of software included in the virtual machine VM to be moved is violated in a case where the virtual machine VM is moved to another physical server PSV in order to add a CPU. It is possible to determine whether or not license of software included in the virtual machine VM to be moved is violated in a case where the virtual machine VM is moved to another physical server PSV in order to add or remove a CPU. Further, it is possible to determine whether or not license violation occurs in the software included in the virtual machine VM brought back to the physical server PSV after a CPU has been added, by addition of the CPU. It is possible to determine whether or not license violation occurs in software included in the virtual machine VM in which a vCPU is added, in a case where the vCPU is added. As a result, it is possible to add or remove a CPU in the physical server PSV and to add a vCPU, without violating the license of software installed by the user.

Since the not-used license number indicating the license of software, which becomes surplus when a virtual machine VM is deleted, when a CPU is removed, and when a vCPU is removed is managed, the not-used license number may be used, for example, in a case where a CPU or a vCPU is added. Thus, it is possible to suppress purchase of an extra license by the user.

Since the maximum value is set in the region of the coefficient COEF in the table PSV-SPC by the physical management unit 22A, it is possible to calculate a provisional license number by using the default value of the coefficient COEF even in a case where the manager and the like forget setting of the coefficient COEF. At this time, the coefficient COEF is set to have the maximum value which may be set. Thus, it is possible to suppress the occurrence of violating a license, by managing the license based on the license number calculated by using the coefficient COEF.

Since the region of the management subject MNG is provided in the table SW-LCS, it is possible to manage license information received from the user and license information of software included in the VM image prepared by the provider, by using the common table SW-LCS. Thus, even in a case where the virtual machine VM is moved between physical servers PSV, it is possible to determine whether or not moving the virtual machine VM is possible, by using the common table SW-LCS without depending on the management subject of the software.

Since it is determined whether or not there is a virtual machine VM including unknown software of which license information has not been set, by referring to the table SW-LCS at a predetermined cycle, it is possible to detect omission of setting license information by the user and to urge the user to input the license information. Since the omission of setting the license information is suppressed, it is possible to suppress an occurrence of a situation in which determination of whether or not moving the virtual machine VM is possible is erroneously performed, in a case where the virtual machine VM is moved between physical servers PSV.

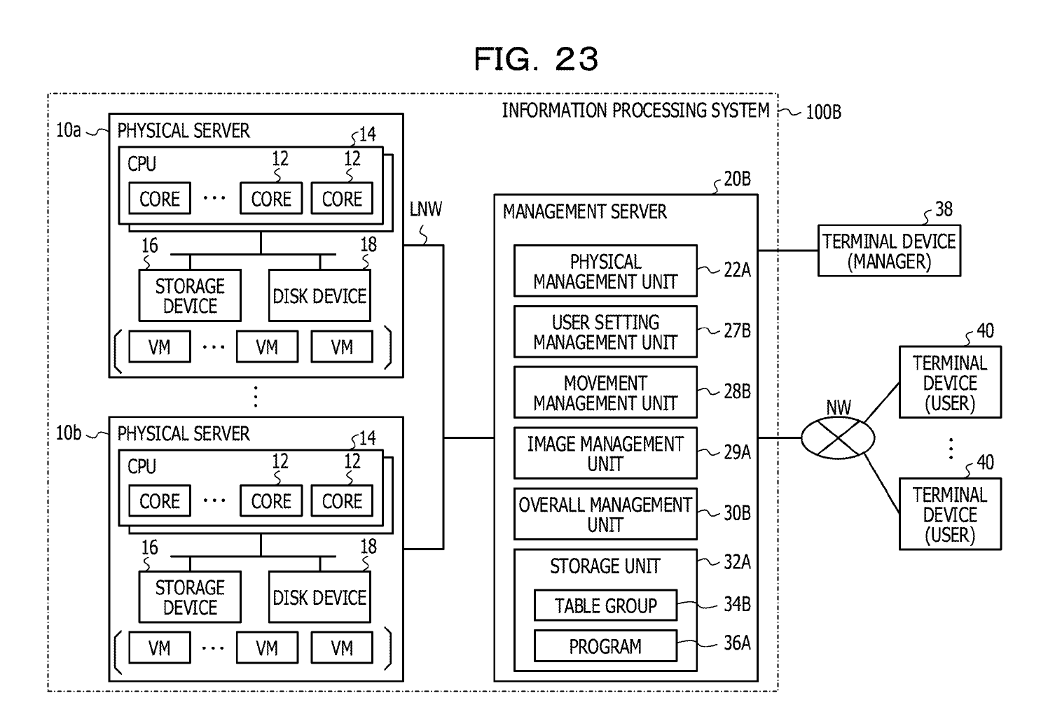

FIG. 23 illustrates an information processing apparatus, an information processing system, and a program according to still another embodiment. The same or similar components as or to those in the embodiments illustrated in FIGS. 1 to 22 are denoted by the same reference signs, and detailed descriptions thereof will not be repeated.

An information processing system 100B illustrated in FIG. 23 includes a management server 20B instead of the management server 20A of the information processing system 100A illustrated in FIG. 3. The management server 20B is an example of the information processing apparatus. The management server 20B includes a user setting management unit 27B, a movement management unit 28B, an overall management unit 30B, and a table group 34B instead of the user setting management unit 27A, the movement management unit 28A, the overall management unit 30A, and the table group 34A illustrated in FIG. 3. The user setting management unit 27B is an example of the interface unit and the virtual management unit. Other components in the information processing system 100B are the same or similar as or to those in the information processing system 100A illustrated in FIG. 3. The management server 20B is coupled to the terminal device 38 operated by the manager. The management server 20B is coupled to the terminal device 40 operated by a user using a virtual machine VM, via the network NW.

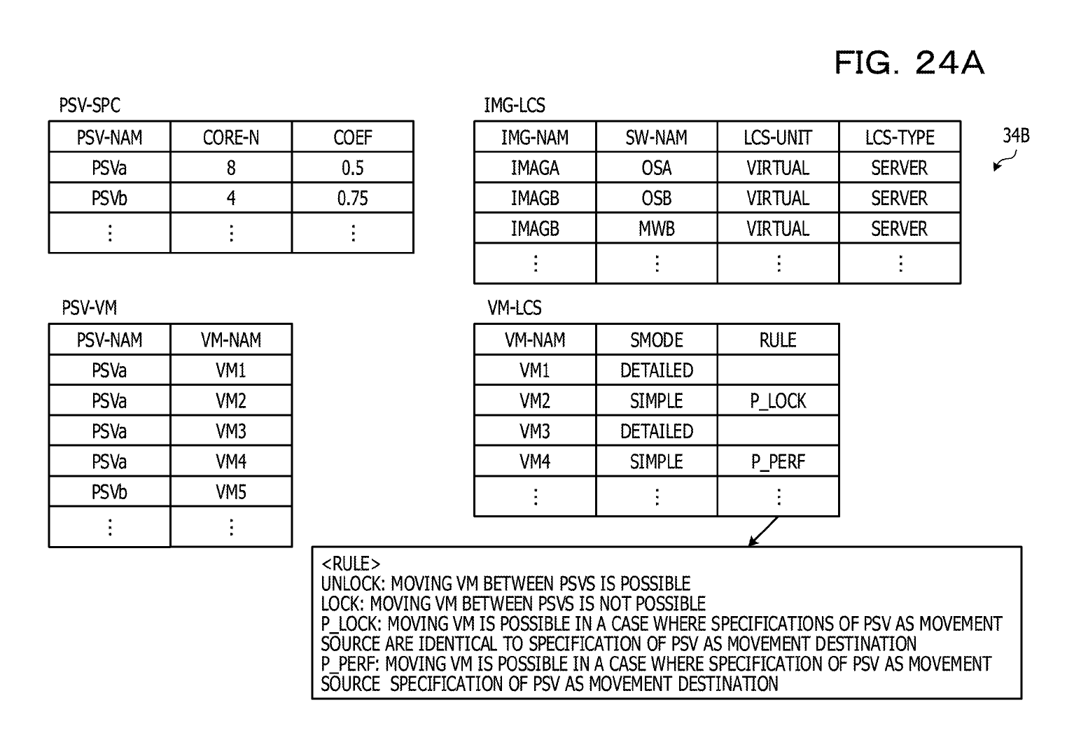

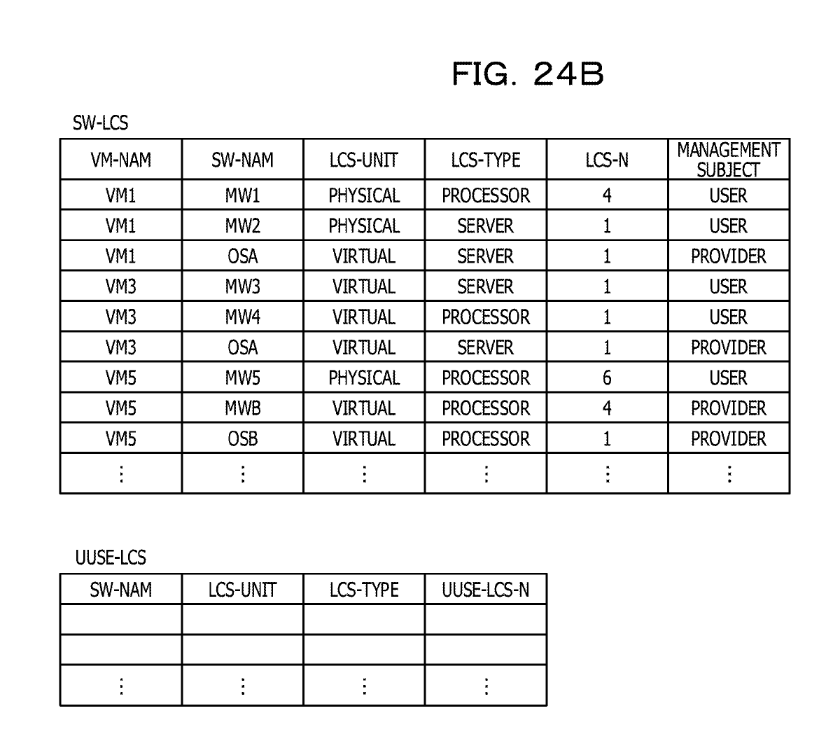

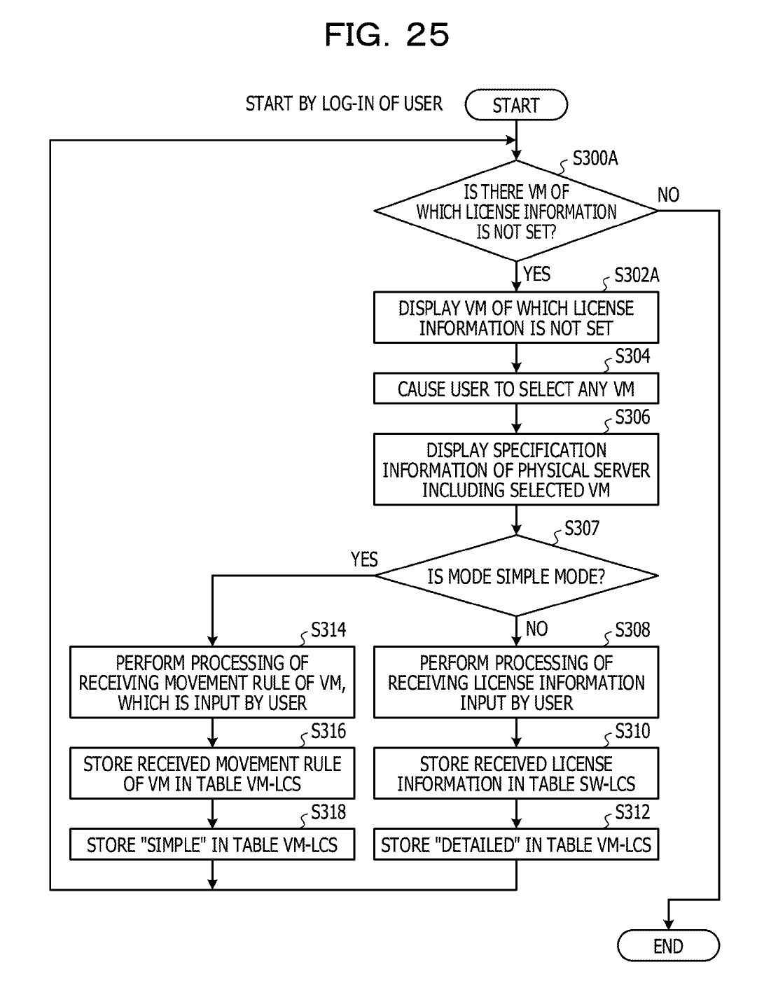

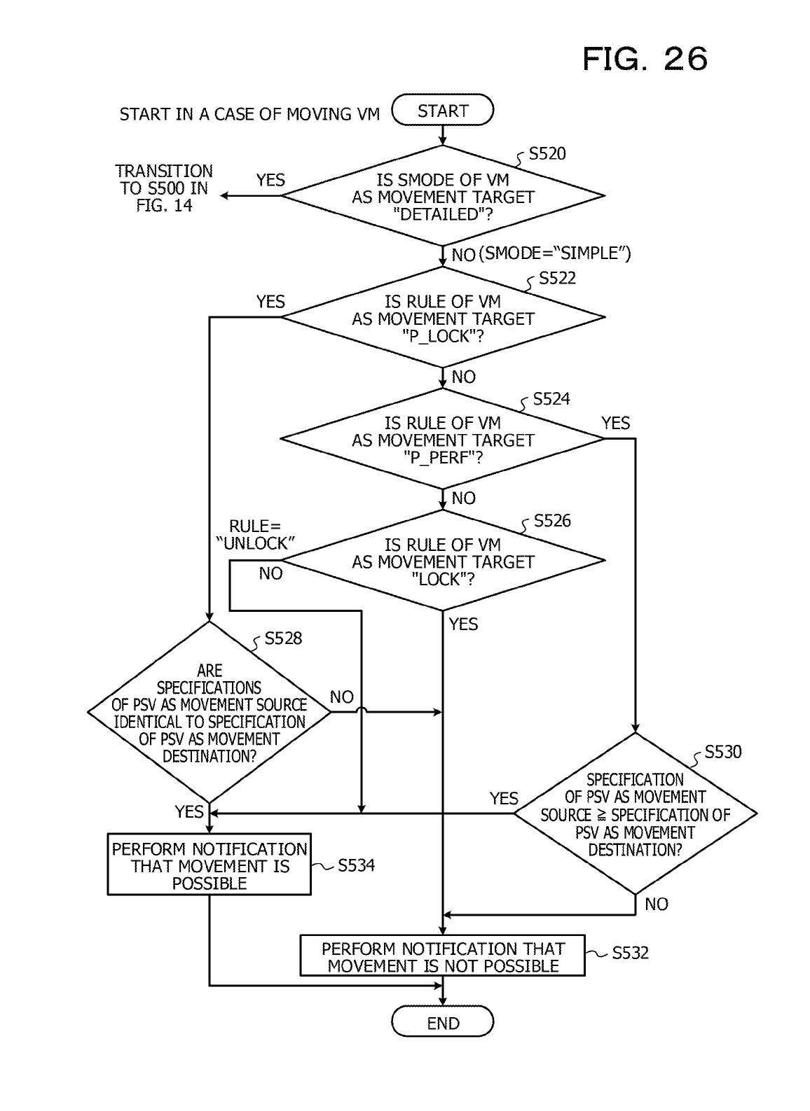

In this embodiment, the management server 20B manages movement of a virtual machine VM based on license information set in the table SW-LCS (FIG. 24) and manages movement of the virtual machine VM based on a movement rule designated to each virtual machine VM. Therefore, a table in which the movement rule is stored for each virtual machine VM is added to the table group 34B in comparison to the table group 34A illustrated in FIG. 3. A function of managing movement of a virtual machine VM based on the movement rule of the virtual machine VM is added to the user setting management unit 27B and the movement management unit 28B in comparison to the user setting management unit 27A and the movement management unit 28A illustrated in FIG. 3. FIG. 25 illustrates an example of an operation of the user setting management unit 27B. FIG. 26 illustrates an example of an operation of the movement management unit 28B. FIG. 24 illustrates an example of the table group 34B.

FIG. 24 (i.e. FIGS. 24A and 24B) illustrates an example of various tables included in the table group 34B illustrated in FIG. 23. The same components as those in FIG. 6 are denoted by the same reference signs, and detailed descriptions thereof will be not repeated. The table group 34B includes a table VM-LCS in addition to the tables PSV-SPC, IMG-LCS, PSV-VM, SW-LCS, and UUSE-LCS included in the table group 34A illustrated in FIG. 6.

The table VM-LCS includes a plurality of records including regions in which a virtual machine name VM-NAM, a setting mode SMODE, and a rule RULE are respectively stored. The table VM-LCS is managed by the user setting management unit 27B. The user setting management unit 27B stores VM information (indicating a relation between a virtual machine VM and a physical server PSV) in the table PSV-VM, and stores the virtual machine name VM-NAM in the table VM-LCS, based on that a virtual machine VM has been created in a physical server 10.

Information indicating any of whether (“detailed”) license information of software installed by the user among pieces of software included in a virtual machine VM is set in detail and whether (“simple”) the license information thereof is simply set is stored in the region of the setting mode SMODE. In a case where the setting mode SMODE is set to be “detailed”, license information of software installed by the user is set in the table SW-LCS by the user setting management unit 27B based on an input from the user. In the following descriptions, a state where the setting mode SMODE has been set to be “detailed” is also referred to as a detailed mode, and a state where the setting mode SMODE has been set to be “simple” is also referred to as a simple mode.

In a case where the setting mode SMODE has been set to be “simple”, the rule RULE is set by the user setting management unit 27B based on an input (of a movement rule in a case where the virtual machine VM moves between physical servers PSV) from the user. For example, any of “UNLOCK”. “LOCK”. “P_LOCK”, and “P_PERF” is stored in the region of the rule RULE.

“UNLOCK” indicates that moving a virtual machine VM between physical servers PSV is possible. “LOCK” indicates that moving a virtual machine VM between physical servers PSV is not possible. “P_LOCK” indicates that moving a virtual machine VM is possible in a case where the specifications of the physical server PSV as a movement source of a virtual machine VM are identical to specifications of a physical server PSV as a movement destination of the virtual machine VM. For example, the specifications of the physical server PSV are indicated by a product of the total number CORE-N of CPU cores provided in a physical server PSV and the coefficient COEF.

“P_PERF” indicates that moving a virtual machine VM is possible in a case where the specifications of a physical server PSV as a movement source of the virtual machine VM is identical to or lower than the specifications of a physical server PSV as a movement destination of the virtual machine VM. The rule RULE is an example of movement determination information indicating that moving a virtual machine VM on which software has been installed, to another physical server 10 is possible. In the following descriptions, the rule RULE is also referred to as a movement rule. A pair of “simple” of the setting mode SMODE and the rule RULE may be referred to as license information in the table VM-LCS.

In a case where license information of software installed on a virtual machine VM is set to be detailed, the user operating the terminal device 40 selects the detailed mode and inputs license information on a setting screen of the terminal device 40. The user setting management unit 27B stores the license information input from the user in the detailed mode, in the table SW-LCS. Thus, the movement management unit 28B may determine whether or not moving a virtual machine VM between physical servers PSV is possible, based on the license information stored in the table SW-LCS.

In a case where license information of software installed on a virtual machine VM is set to be simple, the user selects the simple mode and inputs a movement rule of the virtual machine VM to the setting screen of the terminal device 40. The user setting management unit 27B stores the movement rule of the virtual machine VM, which has been input from the user in the simple mode, in the region of the rule RULE in the table VM-LCS. Thus, the movement management unit 28B may determine whether or not moving a virtual machine VM between physical servers PSV is possible, based on the rule RULE stored in the table VM-LCS, for each virtual machine VM. In a case where the user selects the detailed mode, the user setting management unit 27B stores information indicating “detailed”, in the region of the setting mode SMODE in the table VM-LCS. In a case where the user selects the simple mode, the user setting management unit 27B stores information indicating “simple”, in the region of the setting mode SMODE in the table VM-LCS.

Since the table VM-LCS is provided, the movement management unit 28B may determine whether or not moving a virtual machine VM between physical servers PSV is possible, without causing the user to set detailed license information of all pieces of software included in the virtual machine VM, in detail. Thus, it is possible to reduce a burden of the user on storing license information in the table SW-LCS in comparison to a case of setting license information by using only the table SW-LCS. For example, in a case where the number of pieces of software installed on a virtual machine VM by the user is large, a burden of the user on setting software information for each piece of software is large. In a case where the license of software may be managed in a unit of a virtual machine, it is possible to reduce the burden of the user by setting the movement rule in the simple mode instead of the license information. For example, in a case where types of licenses of software installed on a virtual machine VM are different from each other, the movement rule may be set in the simple mode, with matching with the most strict license. Thus, it is possible to suppress an occurrence of a situation in which license violation occurs in plural pieces of software which is included in a virtual machine VM to be moved to another physical server PSV and has types different from each other, in a case where the movement rule instead of the license information is set in a unit of a virtual machine VM.

The user may also store the license information in the table SW-LCS in a manner that the user sets the setting mode SMODE to be the simple mode, temporarily sets the rule RULE to be “LOCK”, and then sets the setting mode SMODE to be the detailed mode.

FIG. 25 illustrates an example of an operation of the user setting management unit 27B illustrated in FIG. 23. That is, FIG. 25 illustrates an example of an information processing method by the management server 20B and a program executed by the management server 20B. The same or similar components as or to those in FIG. 11 are denoted by the same reference signs, and detailed descriptions thereof will not be repeated. The operation illustrated in FIG. 23 is started based on that the user has logged into the cloud service realized by the information processing system 100B, with the terminal device 40.

Firstly, in Step S300A, the user setting management unit 27B determines whether or not a virtual machine VM in which license information is not set in the tables SW-LCS and VM-LCS is provided among virtual machines VM held by the user who has performed log-in. In a case where the virtual machine VM in which the license information is not set in the tables SW-LCS and VM-LCS, the process proceeds to Step S302A. In a case where license information is set for all virtual machines VM, the process ends.

Here, in a case where the setting mode SMODE is not stored in a record of the table VM-LCS, which includes a virtual machine name VM-NAM indicating the virtual machine VM held by the user, the user setting management unit 27B determines that the license information has not been set. In a case where the license information is not stored in a record of the table SW-LCS, which includes a virtual machine name VM-NAM indicating the virtual machine VM held by the user, the user setting management unit 27B determines that the license information has not been set.

In Step S302A, the user setting management unit 27B displays a virtual machine name VM-NAM indicating the virtual machine VM having a determination that license information thereof has not been set in the tables VM-LCS and SW-LCS, on the screen of the terminal device 40 in which the user has performed log-in. Even in a case where the process of Step S300A is omitted, and the virtual machine VM in which the license information has not been set is not provided, the user setting management unit 27B may perform the process of Step S302A, and thus display all virtual machine VM used by the user. Thus, the user may change license information which has been set once. For example, the user may temporarily set the setting mode SMODE and the rule RULE in the table VM-LCS to be “simple” and “LOCK”, and then set the setting mode SMODE to be the detailed mode. Then, the license information may be stored in the table SW-LCS.

Then, in Step S304, the user setting management unit 27B causes the user to select any of virtual machines VM displayed on the screen of the terminal device 40, through the terminal device 40. In Step S306, the user setting management unit 27B displays specification information of a physical server PSV including the virtual machine VM selected by the user, on the screen of the terminal device 40. The specification information displayed on the screen includes the number CORE-N of cores and the coefficient COEF.

In Step S307, the user setting management unit 27B displays a window of causing the user to select whether the user inputs license information in the simple mode or the detailed mode, on the screen of the terminal device 40 in which the user has performed log-in. In a case where the user selects the simple mode, the process proceeds to Step S314. In a case where the user selects the detailed mode, the process proceeds to Step S308. The user setting management unit 27B may display the window for both the simple mode and the detailed mode on the screen of the terminal device 40, and determine the process to be performed among Steps S308 and S314.

The processes of Steps S308 and S310 are similar to Steps S308 and S310 in FIG. 11. That is, the user setting management unit 27B stores information indicating the virtual machine name VM-NAM, the software name SW-NAM, and “user”, in an empty record in the table SW-LCS. The user setting management unit 27B stores the purchase unit LCS-UNIT, the license type LCS-TYPE, and the license number LCS-N of a license, which have been input by the user, in the record holding the virtual machine name VM-NAM in the table SW-LCS. Then, in Step S312, the user setting management unit 27B stores information indicating “detailed”, in the region of the setting mode SMODE in a record corresponding to the virtual machine VM selected by the user, in the table VM-LCS. Then, the user setting management unit 27B causes the process to return to Step S300A.

In a case where the simple mode is selected, in Step S314, the user setting management unit 27B displays a window for causing the user to input the rule RULE which is the movement rule of the virtual machine VM, on the screen of the terminal device 40. The user setting management unit 27B performs processing of receiving the rule RULE input by the user with the terminal device 40. Then, in Step S316, the user setting management unit 27B stores the rule RULE input by the user, in the region of the rule RULE in the record corresponding to the virtual machine VM selected by the user, in the table VM-LCS. In Step S318, the user setting management unit 27B stores information indicating “simple” in the region of the setting mode SMODE in the record corresponding to the virtual machine VM selected by the user, in the table VM-LCS. Then, the user setting management unit 27B causes the process to return to Step S300A.

In a case where the user setting management unit 27B has received an instruction to delete a virtual machine VM, from the user via the terminal device 40, the user setting management unit 27B performs the operation illustrated in FIG. 13. In this case, in Step S400 in FIG. 13, the user setting management unit 27B searches for the table VM-LCS in addition to the table SW-LCS and finds a record including a virtual machine name VM-NAM indicating the deleted virtual machine VM. The user setting management unit 27B deletes information held in the found record.

FIG. 26 illustrates an example of the operation of the movement management unit 28B illustrated in FIG. 23. That is, FIG. 26 illustrates an example of the information processing method by the management server 20B and the program executed by the management server 20B. The operation illustrated in FIG. 26 is started based on an instruction from the overall management unit 30B, before the management server 20B moves the virtual machine VM between physical servers 10. The operation of the movement management unit 28B is represented by the flow illustrated in FIG. 26 and the flow illustrated in FIG. 14.

Firstly, in Step S520, the movement management unit 28B refers to the table VM-LCS so as to determine whether or not the setting mode SMODE set in the virtual machine VM as a movement target is “detailed”. In a case where the setting mode SMODE is “detailed”, the process proceeds to Step S500 in FIG. 14 in order to determine whether or not moving the virtual machine VM is possible based on the information held in the table SW-LCS. In a case where the setting mode SMODE is not “detailed”, that is, in a case of “simple”, the process proceeds to Step S522.

In Step S522, the movement management unit 28B refers to the table VM-LCS so as to determine whether or not the rule RULE set in the virtual machine VM as the movement target is “P_LOCK”. In a case where the rule RULE is “P_LOCK”, the process proceeds to Step S528. In a case where the rule RULE is not “P_LOCK”, the process proceeds to Step S524.

In Step S524, the movement management unit 28B refers to the table VM-LCS so as to determine whether or not the rule RULE set in the virtual machine VM as the movement target is “P_PERF”. In a case where the rule RULE is “P_PERF”, the process proceeds to Step S530. In a case where the rule RULE is not “P_PERF”, the process proceeds to Step S526.

In Step S526, the movement management unit 28B refers to the table VM-LCS so as to determine whether or not the rule RULE set in the virtual machine VM as the movement target is “LOCK”. In a case where the rule RULE is “LOCK”, moving the virtual machine VM is not possible. Thus, the process proceeds to Step S532. In a case where the rule RULE is not “LOCK”, that is, in a case of “UNLOCK”, moving the virtual machine VM is possible. Thus, the process proceeds to Step S534.

In Step S528, the movement management unit 28B refers to, for example, the table PSV-SPC so as to determine whether or not the specifications of a physical server PSV as a movement source of the virtual machine VM are identical to the specifications of a physical server PSV as a movement destination of the virtual machine VM. In a case where the specifications of the physical servers PSV are identical to each other, moving the virtual machine VM is possible. Thus, the process proceeds to Step S534. In a case where the specifications of the physical servers PSV are different from each other, moving the virtual machine VM is not possible. Thus, the process proceeds to Step S532.

In Step S530, the movement management unit 28B refers to, for example, the table PSV-SPC so as to determine whether or not the specifications of the physical server PSV as the movement source of the virtual machine VM are identical to or higher than the specifications of the physical server PSV as the movement destination of the virtual machine VM. In a case where the specifications of the physical server PSV as the movement source are identical to or higher than the specifications of the physical server PSV as the movement destination, moving the virtual machine VM is possible. Thus, the process proceeds to Step S534. In a case where the specifications of the physical server PSV as the movement source are lower than the specifications of the physical server PSV as the movement destination, moving the virtual machine VM is not possible. Thus, the process proceeds to Step S532.

In Step S532, the movement management unit 28B notifies the overall management unit 30B of not-possibility information indicating that moving the virtual machine VM is not possible. Then, the movement management unit 28B ends the process. The overall management unit 30B receiving the not-possibility information notifies the user, for example, that moving the virtual machine VM is not possible because the license number is insufficient, via the terminal device 40. Then, the overall management unit 30B urges the user to purchase a license.

In Step S534, the movement management unit 28B notifies the overall management unit 30B of possibility information indicating that moving the virtual machine VM is possible, and then ends the process. The operation of the overall management unit 30B receiving the not-possibility information and the operation of the overall management unit 30B receiving the possibility information are similar to the operation described in Steps S510 and S512 in FIG. 14.

The operation of the overall management unit 30B is similar to the operation of the overall management unit 30A described with reference to FIGS. 3 to 23. The overall management unit 30B causes the movement management unit 28B instead of the movement management unit 28A illustrated in FIG. 3 to determine whether or not adding a CPU is possible, in Step S614 in FIG. 18. The overall management unit 30B causes the movement management unit 28B instead of the movement management unit 28A illustrated in FIG. 3 to determine whether or not removing a CPU is possible, in Step S714 in FIG. 20.

In Step S800 in FIG. 21, in a case where the setting mode SMODE which has been held in the table VM-LCS with corresponding to the virtual machine VM as the determination target is “simple”, the overall management unit 30B acquires the information held in the region of the rule RULE, as the license information. In Step S802 in FIG. 21, in a case where the rule RULE which has been held in the table VM-LCS with corresponding to the virtual machine VM as the determination target is “UNLOCK”, the overall management unit 30B causes the process to proceed to Step S808. In Step S802, in a case where the rule RULE which has been held in the table VM-LCS with corresponding to the virtual machine VM as the determination target is “P_LOCK” or “P_PERF”, the overall management unit 30B causes the process to proceed to Step S804. In Step S802, in a case where the rule RULE which has been held in the table VM-LCS with corresponding to the virtual machine VM as the determination target is “LOCK”, the overall management unit 30B causes the process to proceed to Step S814.

In Step S900 in FIG. 22, in a case where the setting mode SMODE which has been held in the table VM-LCS with corresponding to the virtual machine VM in which a vCPU has been removed is “simple”, the overall management unit 30B acquires the information held in the region of the rule RULE, as the license information. In Step S902 in FIG. 22, in a case where the rule RULE which has been held in the table VM-LCS with corresponding to the virtual machine VM in which a vCPU has been removed is “UNLOCK”, the overall management unit 30B causes the process to proceed to Step S904. In Step S802, in a case where the rule RULE which has been held in the table VM-LCS with corresponding to the virtual machine VM in which a vCPU has been removed is “P_LOCK”, “P_PERF”, or “LOCK”, the overall management unit 30B ends the process.

As described above, even in the embodiment illustrated in FIGS. 23 to 26, it is possible to obtain effects similar to those in the embodiments illustrated in FIGS. 1 to 22. For example, it is possible to manage software information of software installed by a user with the table group 34B. Thus, it is possible to determine whether or not moving a virtual machine VM on which the software has been installed by the user between physical servers PSV is possible. Specifically, it is possible to determine whether or not license of software is violated with following addition or removal of a CPU in a physical server PSV, in a case where the virtual machine VM is moved between the physical servers PSV. In other words, it is possible to add or remove a CPU in the physical server PSV, without violating the license of software installed by the user.

Since the not-used license number generated when the virtual machine VM is deleted is managed, for example, the not-used license number may be used when a CPU or a vCPU is added. Thus, it is possible to suppress purchase of the extra license by the user. Since the license information received from the user and the license information of software included in a VM image prepared by the provider are managed by using the common table SW-LCS, it is possible to determine whether or not moving the virtual machine VM is possible without depending on the management subject of the software.

In the embodiment illustrated in FIGS. 23 to 26, since the table VM-LCS used for allowing the movement rule of a virtual machine VM to be set is provided, it is possible to cause the user to set the license information in a unit of a virtual machine VM, not in a unit of software. Thus, it is possible to reduce the information volume of license information input by the user and to reduce a burden of the user. The management server 20B may determine whether or not moving the virtual machine VM between the physical servers PSV is possible, even in a case where the license information is set in the simple mode. As a result, it is possible to add or remove a CPU in the physical server PSV without violating the license of software installed by the user.

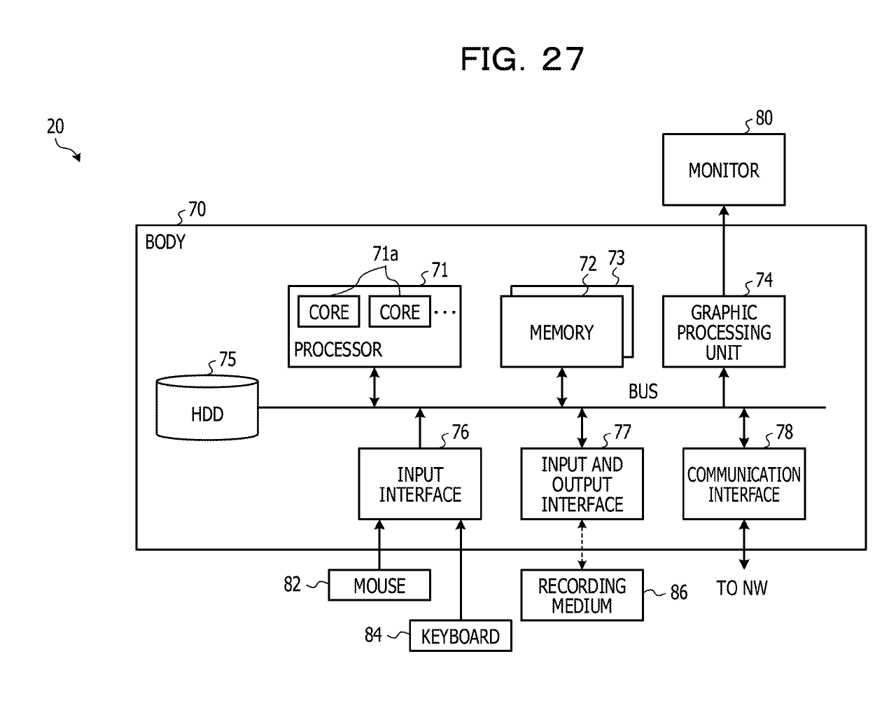

FIG. 27 illustrates an example of a hardware configuration of the management server illustrated in FIGS. 1, 3, and 23. Hardware configurations of the management server 20 illustrated in FIG. 1, the management server 20A illustrated in FIG. 3, and the management server 20B illustrated in FIG. 23 are similar to each other. Thus, in the following descriptions, the configuration of the management server 20 will be described. The physical server 10, and the terminal devices 38 and 40 illustrated in FIG. 3 have hardware configurations which are the same as or similar to those in FIG. 27.

The management server 20 includes a main body 70 such as a motherboard, and a monitor 80, a mouse 82, and a keyboard 84 which are coupled to the main body 70. The main body 70 includes a processor 71 such as a CPU, memories 72 and 73, a graphic processing unit 74, a hard disk drive (HDD) 75, an input interface 76, an input and output interface 77, and a communication interface 78 which are coupled to each other via a bus BUS. The main body 70 may include a FPGA.

The processor 71 includes a plurality of processor cores 71a performing arithmetic operational processing. The main body 70 may include a plurality of processors 71. Any of the processor cores 71a executes a program so as to realize the function of the management server 20 illustrated in FIG. 1, the management server 20A illustrated in FIG. 3, or the management server 20B illustrated in FIG. 23. In a case where the plurality of processors 71 is provided in the main body 70, any of the plurality of processors 71 may execute the program.

For example, the memory 72 is a memory module in which a plurality of SDRAMs is mounted. The memory 73 is a flash memory. The graphic processing unit 74 outputs image data and the like to be displayed on a screen of the monitor 80 to the monitor 80 based on an instruction from the processor 71. The HDD 75 holds various programs and the like executed by the processor 71. The processor 71 executes various programs transferred from the HDD 75 to the memory 72.

The input interface 76 transmits a signal received from an input device such as the mouse 82 and the keyboard 84 to the processor 71. The input and output interface 77 reads information of various programs or various kinds of data from a recording medium 86 and writes the read information in the HDD 75 and the like, based on an instruction from the processor 71. The input and output interface 77 reads the information stored in the HDD 75 and the like and writes the read information in a recording medium 86, based on an instruction from the processor 71. As the recording medium 86, a Compact Disc (CD: registered trademark), a Digital Versatile Disc (DVD: registered trademark), a universal serial bus (USB) memory, or the like is provided. The communication interface 78 transmits and receives information to and from another device coupled to the network, via the network such as the network NW.

With the above detailed description, the features and advantages of the embodiments will become apparent. This is intended to cover the features and advantages of the embodiments as described above without departing from the spirit and scope of the claims. Anyone with ordinary skill in the art may readily conceive of all improvements and modifications. Therefore, there is no intention to limit the scope of the embodiment having the inventive aspect to those described above, and it is also possible to rely on appropriate improvements and equivalents included in the range disclosed in the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus for managing a physical machine in which a virtual machine to be used by a user is set, the information processing apparatus comprising:
a memory; and
a processor coupled to the memory and configured to
execute physical management processing that includes managing performance information depending on performance of the physical machine, for each physical machine, the performance information being information used for calculating a license number indicating the number of licenses assigned to software to be operated on the virtual machine,
execute interface processing that includes
outputting the performance information to a user terminal operated by the user, after the software has been installed on the virtual machine, and
receiving license information including the license number assigned to the installed software, from the user terminal, and
execute virtual management processing that includes managing software information indicating a correspondence between the license information received by the interface processing, the software to which the license number included in the license information is assigned, and the virtual machine on which the software has been installed.

2. The information processing apparatus according to claim 1,
wherein the processor is further configured to
execute movement management processing that includes determining whether or not moving the virtual machine to another physical machine is possible, based on the license information managed by the virtual management processing.

3. The information processing apparatus according to claim 2,
wherein the movement management processing is configured to permit moving of the virtual machine when the license information managed by the virtual management processing includes first license information and when the license number included in the license information is equal to or greater than a license number calculated from the performance information of the physical machine as a movement destination of the virtual machine, the first license information being information indicating that the license is set in a unit of a physical machine and indicating that the license is set to depend on a number of cores of a processor in the physical machine.

4. The information processing apparatus according to claim 1,
wherein the interface processing is configured to receive any of the license information or movement determination information from the user terminal after the performance information has been output to the user terminal, the movement determination information indicating whether or not moving the virtual machine on which the software has been installed to another physical machine is possible, and
wherein the virtual management processing is configured to
manage the software information for each piece of software in a case where the license information has been received from the user terminal, and
manage the movement determination information for each virtual machine in a case where the movement determination information has been received from the user terminal.

5. The information processing apparatus according to claim 1,
wherein the processor is configured to
execute addition management processing that includes determining whether or not adding a processor provided in the physical machine in which the virtual machine on which the software has been installed has been set is possible, based on information managed by the virtual management processing.

6. The information processing apparatus according to claim 5,
wherein the addition management processing is configured to permit addition of the processor when, in the software installed on the virtual machine set in the physical machine in which the processor is to be added, the license information managed by the virtual management processing includes first license information, and when the license number included in the license information is equal to or greater than a license number calculated from the performance information of the physical machine as a movement destination of the virtual machine moving from the physical machine in which the processor is added, the first license information being information indicating that the license is set in a unit of a physical machine and indicating that the license is set to depend on the number of cores of the processor in the physical machine.

7. The information processing apparatus according to claim 1,
wherein the virtual management processing is configured to
delete the software information corresponding to the virtual machine in a case where the virtual machine on which the software has been installed has been deleted from the physical machine, and
manage the license number included in the deleted software information, as a not-used license number.

8. The information processing apparatus according to claim 1,
wherein the performance information includes a number of cores of the processor provided in the physical machine and a coefficient to be multiplied by the number of cores,
wherein, in a case where a license required for the software is set in a unit of a physical machine and is set to depend on the number of cores of the processor in the physical machine, the license number is indicated by a product of the number of cores and the coefficient, and
wherein the physical management processing is configured to set the coefficient to a maximum value allowed to be set, until a correct coefficient is received from a manager terminal operated by a manager of the information processing apparatus.

9. The information processing apparatus according to claim 1,
wherein the processor is configured to
execute image management processing that includes
managing second software information common with the software information managed by the virtual management processing, in a case where the virtual machine is set in the physical machine by using an image including configuration data of the virtual machine and program data of software set in the virtual machine, the second software information indicating a correspondence between the software included in the image, the license information including a license number assigned to the software, and the virtual machine set in the physical machine by using the image.

10. The information processing apparatus according to claim 1,
wherein the processor is configured to
execute software information holding processing that includes holding the software information, and
wherein the virtual management processing is configured to
store installation information in the by the software information holding processing based on installation of the software on the virtual machine, the installation information indicating the installed software and the virtual machine on which the software has been installed,
detect whether the license number corresponding to the installation information is held as the software information by the software information holding processing, at a predetermined cycle,
issue an instruction to require an input of a license number to the user, by the interface processing in a case where the license number corresponding to the installation information is not held by the software information holding processing, and
store the license number received from the user terminal, by the software information holding processing.

11. An information processing system comprising:
a physical machine in which a virtual machine to be used by a user is set; and
an information processing apparatus that manages the physical machine,
wherein the information processing apparatus includes
a physical management unit that manages performance information for each physical machine, the performance information being used for calculating a license number indicating the number of licenses assigned to software operated on the virtual machine and depending on performance of the physical machine,
an interface unit that outputs the performance information to a user terminal operated by the user and receives license information including a license number assigned to software from the user terminal, after the software has been installed on the virtual machine, and
a virtual management unit that manages software information indicating a correspondence between the license information received by the interface unit, software to which the license number included in the license information is assigned, and the virtual machine on which the software has been installed.

12. A non-transitory computer-readable storage medium for storing a program which causes a processor to perform processing for managing a physical machine in which a virtual machine to be used by a user is set, the processing comprising:
executing physical management processing that includes managing performance information depending on performance of the physical machine, for each physical machine, the performance information being information used for calculating a license number indicating the number of licenses assigned to software to be operated on the virtual machine,
executing interface processing that includes
outputting the performance information to a user terminal operated by the user, after the software has been installed on the virtual machine, and
receiving license information including the license number assigned to the installed software, from the user terminal, and
executing virtual management processing that includes managing software information indicating a correspondence between the license information received by the interface processing, the software to which the license number included in the license information is assigned, and the virtual machine on which the software has been installed.

13. The non-transitory computer-readable storage medium according to claim 12,
wherein the processing further comprises:
executing movement management processing that includes determining whether or not moving the virtual machine to another physical machine is possible, based on the license information managed by the virtual management processing.

14. The non-transitory computer-readable storage medium according to claim 13,
wherein the movement management processing is configured to permit moving of the virtual machine when the license information managed by the virtual management processing includes first license information and when the license number included in the license information is equal to or greater than a license number calculated from the performance information of the physical machine as a movement destination of the virtual machine, the first license information being information indicating that the license is set in a unit of a physical machine and indicating that the license is set to depend on a number of cores of a processor in the physical machine.

15. The non-transitory computer-readable storage medium according to claim 12,
wherein the interface processing is configured to receive any of the license information or movement determination information from the user terminal after the performance information has been output to the user terminal, the movement determination information indicating whether or not moving the virtual machine on which the software has been installed to another physical machine is possible, and
wherein the virtual management processing is configured to
manage the software information for each piece of software in a case where the license information has been received from the user terminal, and
manage the movement determination information for each virtual machine in a case where the movement determination information has been received from the user terminal.

16. The non-transitory computer-readable storage medium according to claim 12,
wherein the processing further comprises:
executing addition management processing that includes determining whether or not adding a processor provided in the physical machine in which the virtual machine on which the software has been installed has been set is possible, based on information managed by the virtual management processing.

17. The non-transitory computer-readable storage medium according to claim 16,
wherein the addition management processing is configured to permit addition of the processor when, in the software installed on the virtual machine set in the physical machine in which the processor is to be added, the license information managed by the virtual management processing includes first license information, and when the license number included in the license information is equal to or greater than a license number calculated from the performance information of the physical machine as a movement destination of the virtual machine moving from the physical machine in which the processor is added, the first license information being information indicating that the license is set in a unit of a physical machine and indicating that the license is set to depend on the number of cores of the processor in the physical machine.

18. The non-transitory computer-readable storage medium according to claim 12,
wherein the virtual management processing is configured to
delete the software information corresponding to the virtual machine in a case where the virtual machine on which the software has been installed has been deleted from the physical machine, and
manage the license number included in the deleted software information, as a not-used license number.

19. The non-transitory computer-readable storage medium according to claim 12,
wherein the performance information includes a number of cores of the processor provided in the physical machine and a coefficient to be multiplied by the number of cores,
wherein, in a case where a license required for the software is set in a unit of a physical machine and is set to depend on the number of cores of the processor in the physical machine, the license number is indicated by a product of the number of cores and the coefficient, and
wherein the physical management processing is configured to set the coefficient to a maximum value allowed to be set, until a correct coefficient is received from a manager terminal operated by a manager of the information processing apparatus.

20. The non-transitory computer-readable storage medium according to claim 12,
wherein the processing further comprises:
executing image management processing that includes
managing second software information common with the software information managed by the virtual management processing, in a case where the virtual machine is set in the physical machine by using an image including configuration data of the virtual machine and program data of software set in the virtual machine, the second software information indicating a correspondence between the software included in the image, the license information including a license number assigned to the software, and the virtual machine set in the physical machine by using the image.
